(19) United States
(12) Patent Application Publication
(10) Pub. No.: US 2025/0264789 A1
(43) Pub. Date: Aug. 21, 2025

(54) PROJECTOR

(71) Applicant: SEIKO EPSON CORPORATION, Tokyo (JP)

(72) Inventor: Takuo YONEYAMA, AZUMINO-SHI (JP)

(21) Appl. No.: 19/056,993

(22) Filed: Feb. 19, 2025

(30) Foreign Application Priority Data
Feb. 20, 2024 (JP) 2024-023907

(51) Int. Cl. G03B 21/20

(52) U.S. Cl. CPC G03B 21/2013; G03B 21/2033; G03B 21/2066

(57) ABSTRACT

A projector of the present disclosure includes a light source, a transmissive optical part, a rotating part, a light modulation device, and a control device. The light modulation device has an image forming region containing a plurality of pixels. The transmissive optical part rotates about a first rotational axis to scan the image forming region of the light modulation device with light emitted from the light source. The control device selects the light control target pixel based on image information, and performs light control.

The present application is based on, and claims priority from JP Application Serial Number 2024-023907, filed Feb. 20, 2024, the disclosure of which is hereby incorporated by reference herein in its entirety.

### BACKGROUND

### 1. Technical Field

The present disclosure relates to a projector.

### 2. Related Art

In the past, there has been a projector that temporally scan a light modulation device such as a liquid crystal panel with light emitted from a light emitting part to thereby illuminate the light modulation device. JP-A-2007-225956 discloses a projector including a light source device including a light source lamp, a liquid crystal light valve, a polygonal mirror disposed between the light source device and the liquid crystal light valve, and a projection lens.

In this projector, the light source device emits light having an elliptical light flux cross section. The polygon mirror reflects the light emitted from the light source device to scan an image forming region of the liquid crystal light valve in a short-axis direction of the elliptical light flux cross section.

JP-A-2007-225956 is an example of the related art.

However, when the polygon mirror is used in the scan with the light as in the projector in JP-A-2007-225956, even when perfectly parallel light is made incident on the polygon mirror, the parallelism of the light is impaired by the polygon mirror. That is, since the polygon mirror reflects the light while rotating, the incidence angle ω f the light with respect to the reflecting surface of the polygon mirror changes with time, and the parallel light incident on the polygon mirror turns to light having a predetermined divergence angle to illuminate the image forming region of the liquid crystal light valve. As a result, there is a problem that the light emitted from the light source device cannot efficiently be used.

### SUMMARY

In order to solve the problem described above, according to a first aspect of the present disclosure, there is provided a projector including
a light source unit configured to emit light,
a first transmissive optical part including a first plane of incidence on which the light emitted from the light source unit is incident, and a first exit surface configured to emit the light incident from the first plane of incidence,
a first rotating part configured to rotate the first transmissive optical part,
a light modulation device configured to modulate, based on image information, the light emitted from the first transmissive optical part to generate image light, and
a control device configured to control an output of the light source unit, in which
the light modulation device includes an image forming region containing a plurality of pixels,
the first transmissive optical part is a light transmissive member having the first plane of incidence and the first exit surface parallel to each other, and rotates around a first rotational axis extending along a second direction crossing a first direction which is an incident direction of the light with respect to the first transmissive optical part to thereby scan the image forming region of the light modulation device with the light emitted from the light source unit,
the control device performs light control of adjusting light intensity of the light to be incident on a target pixel in the image forming region by
setting the light control reference value and the target pixel selected from among the plurality of pixels based on the image information,
decreasing the output of the light source unit when a luminance value corresponding to the target pixel in the image light is smaller than a light control reference value, and
increasing the output of the light source unit when the luminance value is larger than the light control reference value when the following formula is satisfied when defining a position coordinate of the target pixel in the image forming region as (px, py), a radius in a scanning direction of the light on the image forming region as r, and a position coordinate of the light on the image forming region at a time t as (dx(t), dy(t)).

{square root over ({pₓ-dₓ(t)}²{p_{y}−d_{y}(t)}²)}≤r

### BRIEF DESCRIPTION OF THE DRAWINGS

FIG. 1 is a plan view showing a schematic configuration of a projector according to a first embodiment.

FIG. 2 is a block diagram showing an electrical configuration of the projector.

FIG. 3 is a perspective view showing a schematic configuration of a light source device.

FIG. 4A is a schematic diagram illustrating a behavior of light during a rotation of a transmissive optical part.

FIG. 4B is a schematic diagram showing the behavior subsequent to FIG. 4A.

FIG. 4C is a schematic diagram showing the behavior subsequent to FIG. 4B.

FIG. 4D is a schematic diagram showing the behavior subsequent to FIG. 4C.

FIG. 4E is a schematic diagram showing the behavior subsequent to FIG. 4D.

FIG. 4F is a schematic diagram showing the behavior subsequent to FIG. 4E.

FIG. 5 is a schematic diagram showing a transmissive optical part as a simulation model.

FIG. 6 is a diagram showing a periodic function representing a relationship between a rotation angle and a displacement amount.

FIG. 7 is a flowchart representing a flow of processing in light control.

FIG. 8 is a diagram showing a configuration of a principal portion of an image forming region of a first light modulation part.

FIG. 9 is an image diagram showing a locus of scanning light on the image forming region.

FIG. 10 is a diagram illustrating the light control when displaying characters shown in FIG. 8.

FIG. 11 is a diagram showing a change in a displacement amount of a spot of blue light.

FIG. 12 is a diagram illustrating the light control in a second modified example.

FIG. 13 is a plan view showing a schematic configuration of a projector according to a second embodiment.

FIG. 14 is a side view illustrating a configuration of a second light source unit.

FIG. 15 is a diagram showing a state of scanning light on a light modulation device.

FIG. 16 is a cross-sectional view showing a configuration of an essential part of the light modulation device.

### DESCRIPTION OF EMBODIMENTS

### First Embodiment

A first embodiment of the present disclosure will hereinafter be described using the drawings.

A projector according to the present embodiment is an example of a liquid crystal projector using liquid crystal panels as light modulation devices.

In the following drawings, parts are drawn at different dimensional scales in some cases in order to make the parts eye-friendly.

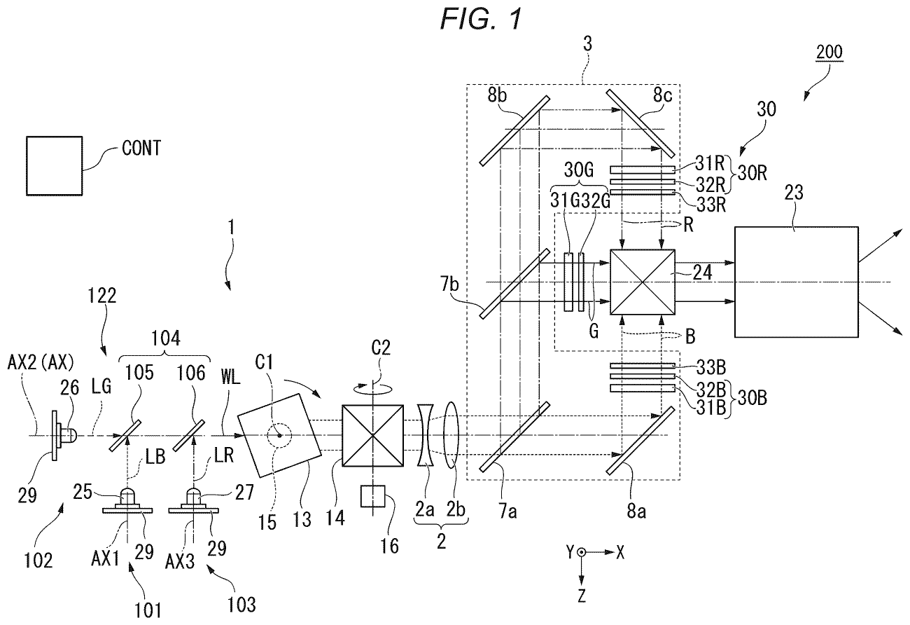

FIG. 1 is a plan view showing a schematic configuration of a projector 200 according to the present embodiment.

As shown in FIG. 1, the projector 200 according to the present embodiment includes a light source device 1, a magnifying optical system 2, a color separation optical system 3, a light modulation device 30, an image light combining part 24, a projection optical device 23, and a control device CONT.

The light source device 1 in the present embodiment includes a light source unit 10, a first transmissive optical part 13, a second transmissive optical part 14, a first rotating part 15, and a second rotating part 16. The light source unit 10 includes a first light source unit 101, a second light source unit 102, a third light source unit 103, and a light combining optical system 104. The control device CONT controls drive of each of the light source unit 10, the first rotating part 15, and the second rotating part 16.

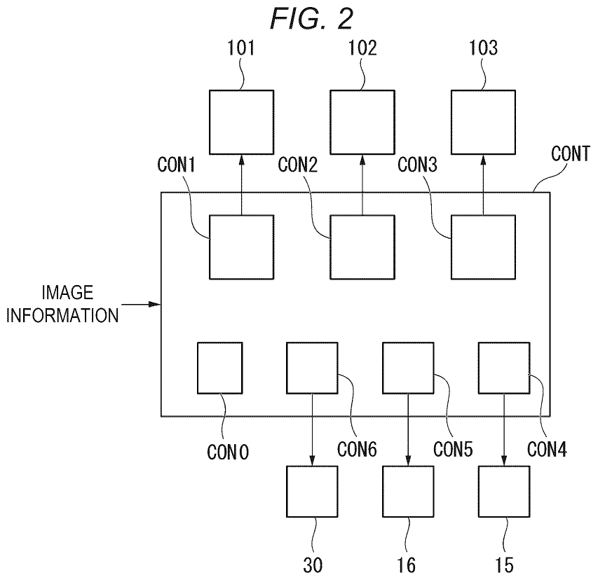

FIG. 2 is a block diagram showing an electrical configuration of the projector 200.

As shown in FIG. 2, the control device CONT is configured with a computer or an integrated circuit which incorporates processing in each of drive devices for driving the light source device 1 and the light modulation device 30 as a program. That is, the control device CONT is, for example, a processor. The control device CONT is coupled to the light source device 1 and the light modulation device 30 wirelessly or by wire (not shown).

The control device CONT includes a first light source drive unit CON1 that controls drive of the first light source unit 101, a second light source drive unit CON2 that controls drive of the second light source unit 102, a third light source drive unit CON3 that controls drive of the third light source unit 103, a first rotation drive unit CON4 that controls drive of the first rotating part 15, a second rotation drive unit CON5 that controls drive of the second rotating part 16, and a panel drive unit CON6 that controls drive of the light modulation device 30.

Since the control device CONT in the present embodiment collectively performs the light control of the light source unit 10, the drive control of the rotating parts 15, 16, and the drive control of the light modulation device 30, simple and accurate control becomes possible.

In the following descriptions, an X-Y−Z orthogonal coordinate system will be used as needed in the drawings. The X axis is an axis parallel to the optical axis AX of the light source unit 10. The optical axis AX of the light source unit 10 is defined as an axis along a principal ray of illumination light WL described later that is emitted from the light source unit 10. An optical axis AX2 of the second light source unit 102 coincides with the optical axis AX of the light source unit 10. The optical axis AX2 of the second light source unit 102 is defined as an axis along a principal ray of green light LG described later and emitted from the second light source unit 102. The Y axis is an axis which is perpendicular to the X axis and extends along a rotational axis of the first transmissive optical part 13. The Z axis is an axis perpendicular to the X axis and the Y axis. The optical axis AX1 of the first light source unit 101 is defined as an axis along a principal ray of blue light LB described later and emitted from the first light source unit 101. An optical axis AX3 of the third light source unit 103 is defined as an axis along a principal ray of red light LR described later and emitted from the third light source unit 103. An X-axis direction in the present embodiment corresponds to a “first direction” in the appended claims. A Y-axis direction in the present embodiment corresponds to a “second direction” in the appended claims. A Z-axis direction in the present embodiment corresponds to a “third direction” in the appended claims.

The first light source unit 101 is arranged such that the optical axis AX1 of the first light source unit 101 is orthogonal to the optical axis AX2 of the second light source unit 102. The third light source unit 103 is arranged such that the optical axis AX3 of the third light source unit 103 is orthogonal to the optical axis AX2 of the second light source unit 102. The first light source unit 101 emits the blue light (first light) LB toward the −Z side. The third light source unit 103 emits the red light (third light) LR toward the −Z side. The second light source unit 102 emits the green light (second light) LG toward the +X side. In this example, the first light source unit 101 is disposed at a side closer to the second light source unit 102, and the third light source unit 103 is disposed at a side farther from the second light source unit 102, but this arrangement may be reversed.

The first light source unit 101 includes a first light emitting part 25 and a substrate 29. The first light emitting part 25 is formed of a laser diode that emits a light beam in a first wavelength band. Therefore, the light beam emitted from the first light emitting part 25 is linearly-polarized light having coherency, and is a laser beam narrow in light flux width and high in parallelism. The first wavelength band is, for example, a blue wavelength band in a range of 450 nm±5 nm. That is, the first light emitting part 25 emits the blue light LB as the first light.

The second light source unit 102 includes a second light emitting part 26 and a substrate 29. The second light emitting part 26 is formed of a laser diode that emits a light beam in a second wavelength band different from the first wavelength band. The light beam emitted from the second light emitting part 26 is linearly-polarized light having coherency, and is a laser beam narrow in light flux width and high in parallelism. The second wavelength band is, for example, a green wavelength band in a range of 530 nm±5 nm. That is, the second light emitting part 26 emits the green light LG as the second light.

The third light source unit 103 includes a third light emitting part 27 and a substrate 29. The third light emitting part 27 is formed of a laser diode that emits a light beam in a third wavelength band different from the first wavelength band and the second wavelength band. The light beam emitted from the third light emitting part 27 is linearly-polarized light having coherency, and is a laser beam narrow in light flux width and high in parallelism. The third wavelength band is, for example, a red wavelength band in a range of 650 nm±5 nm. That is, the third light emitting part 27 emits the red light LR as the third light.

Note that in the present embodiment, the laser diodes are cited as the light emitting parts 25, 26, and 27, but this is not a limitation, and it is possible to use a light source such as an LED or a lamp, and an optical system for adjusting the polarization direction of the light, an optical system for adjusting the light flux width, a color wheel, and so on in combination with each other.

The light combining optical system 104 includes a first light combining part 105 and a second light combining part 106. The first light combining part 105 is disposed at a position where the optical axes AX1, AX2 cross each other. The first light combining part 105 includes a dichroic mirror that transmits green light and reflects blue light. The second light combining part 106 is provided at a position where the optical axes AX2, AX3 cross each other. The second light combining part 106 is formed of a dichroic mirror that transmits the green light LG and the blue light LB and reflects the red light LR. The light combining optical system 104 combines the blue light LB emitted from the first light source unit 101, the green light LG emitted from the second light source unit 102, and the red light LR emitted from the third light source unit 103 with each other to generate white light LW. Thus, the light source unit 10 emits the white light LW. The white light LW enters the first transmissive optical part 13 without being separated according to the wavelength band.

The first transmissive optical part 13 is disposed between the light source unit 10 and the second transmissive optical part 14 on the optical axis of the light source unit 10. The first transmissive optical part 13 is formed of a light transmissive member that is rotatably supported. The first transmissive optical part 13 is made rotatable around the first rotational axis C1 extending along the Y-axis direction. The first rotational axis C1 is coupled to the first rotating part 15 formed of a motor or the like. The first transmissive optical part 13 rotates about the first rotational axis C1 by the drive of the first rotating part 15.

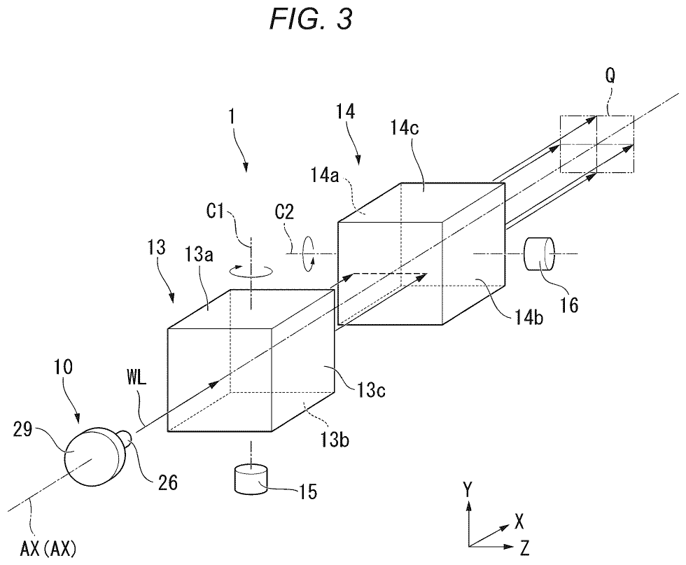

FIG. 3 is a perspective view showing a schematic configuration of the light source device 1. In FIG. 3, in order to make the drawing eye-friendly, illustration of the light source unit 10 is omitted.

As shown in FIG. 3, as the glass material of the light transmissive member constituting the first transmissive optical part 13, there is used a light transmissive material such as optical glass such as BK7, quartz, or resin. The first transmissive optical part 13 includes a first surface 13a and a second surface 13b crossing the first rotational axis C1, and four first side surfaces 13c having perpendicular contact with the first surface 13a and the second surface 13b. That is, the first transmissive optical part 13 has a square prismatic shape having six planar surfaces including the first surface 13a, the second surface 13b, and the four first side surfaces 13c. A cross-sectional shape of the first transmissive optical part 13 cut by a plane perpendicular to the first rotational axis C1 is a square shape. That is, the four first side surfaces 13c have the same area as each other, and any pair of first side surfaces 13c opposed to each other are parallel to each other.

The first transmissive optical part 13 transmits the illumination light WL as white light emitted from the light source unit 10 while rotating about the first rotational axis C1. Therefore, the first side surface 13c, from which the illumination light WL emitted from the light source unit 10 enters the first transmissive optical part 13, is not uniquely determined, but changes with time. Similarly, the first side surface 13c, from which the illumination light WL having entered the first transmissive optical part 13 is emitted to an outside space, is not uniquely determined, but changes with time. In the first transmissive optical part 13, the first side surface 13c on which the illumination light WL emitted from the light source unit 10 is incident is referred to as a first plane of incidence. The first side surface 13c, from which the illumination light WL incident on the first plane of incidence is emitted, is referred to as a first exit surface. The first plane of incidence and the first exit surface change with time, and are any of the pair of first side surfaces 13c parallel to each other out of the four first side surfaces 13c.

In the present specification, when two surfaces of the light transmissive member are referred to as surfaces parallel to each other, when an angle between the two surfaces falls within a range of 0±5 degrees is referred to as “parallel” in consideration of the processing accuracy of the glass material constituting the light transmissive member, an allowable range of the parallelism of the light, and so on.

In the case of the present embodiment, the first transmissive optical part 13 has the four first side surfaces 13c, but the number of first side surfaces 13c is not necessarily four, but is desirably 2×m (m is a natural number no smaller than 2). That is, the number of first side surfaces 13c is preferably an even number no smaller than 4 such as 6 or 8. When the number of first side surfaces 13c is the even number no smaller than 4, all the first side surfaces 13c each become parallel to the first side surface 13c opposed to that first side surface 13c, and there is no first side surface 13c which fails to have a counterpart parallel thereto. Thus, the stray light rarely occurs in the first transmissive optical part 13, and it is possible to increase the light use efficiency.

The second transmissive optical part 14 is disposed at the light exit side of the first transmissive optical part 13 on the optical axis AX of the light source unit 10. The second transmissive optical part 14 is formed of a light transmissive member that is rotatably supported. The second transmissive optical part 14 is made rotatable around the second rotational axis C2 extending along the Z-axis direction. That is, the first rotational axis C1 and the second rotational axis C2 extend in directions perpendicular to each other in an imaginary plane perpendicular to the optical axis AX. The second rotational axis C2 is coupled to the second rotating part 16 formed of a motor or the like. The second transmissive optical part 14 rotates about the second rotational axis C2 by the drive the second rotating part 16.

The light transmissive member that constitutes the second transmissive optical part 14 is substantially the same as the light transmissive member that constitutes the first transmissive optical part 13. As the glass material of the light transmissive member, a light transmissive material such as optical glass such as BK7, quartz, or resin is used. In particular, in the case of the second transmissive optical part 14, unlike the first transmissive optical part 13, since the illumination light LW which has been used for scanning in one direction by the first transmissive optical part 13 is incident on the second transmissive optical part 14, the illumination light WL incident on the second transmissive optical part 14 is lower in light density than the illumination light WL at the time point when entering the first transmissive optical part 13. Therefore, the possibility that a resin material low in light resistance and heat resistance can be used is higher than in the case of the first transmissive optical part 13.

The second transmissive optical part 14 has a third surface 14a and a fourth surface 14b crossing the second rotational axis C2, and four second side surfaces 14c having perpendicular contact with the third surface 14a and the fourth surface 14b. That is, the second transmissive optical part 14 has a square prismatic shape having six planar surfaces including the third surface 14a, the fourth surface 14b, and the four second side surfaces 14c. A cross-sectional shape of the second transmissive optical part 14 cut by a plane perpendicular to the second rotational axis C2 is a square shape. The four second side surfaces 14c have the same area as each other, and any pair of the second side surfaces opposed to each other are parallel to each other.

The second transmissive optical part 14 transmits the illumination light WL emitted from the first transmissive optical part 13 while rotating around the second rotational axis C2. Therefore, the second side surface from which the illumination light WL emitted from the first transmissive optical part 13 enters the second transmissive optical part 14 is not uniquely fixed but changes with time. Similarly, the second side surface from which the illumination light WL incident on the second transmissive optical part 14 is emitted to the outside space is not uniquely fixed, but changes with time. In the second transmissive optical part 14, the second side surface on which the illumination light WL emitted from the first transmissive optical part 13 is incident is referred to as a second plane of incidence. The second side surface from which the illumination light WL incident on the second plane of incidence is emitted is referred to as a second exit surface. In this case, the second plane of incidence and the second exit surface change with time, and are any of the two second side surfaces parallel to each other out of the four second side surfaces 14c.

The second transmissive optical part 14 has the four second side surfaces 14c in the case of the present embodiment, but the number of second side surfaces is not necessarily required to be four, and is desirably 2×n (n is a natural number no smaller than 2). That is, the number of second side surfaces is desirably an even number such as six or eight. When the number of second side surfaces is the even number, all the second side surfaces each become parallel to the second side surface opposed to that second side surface, and there is no second side surfaces parallel to each other. Thus, the stray light rarely occurs in the second transmissive optical part 14, and it is possible to increase the light use efficiency.

The first transmissive optical part 13 and the second transmissive optical part 14 both have a square prismatic shape in the present embodiment, but may be different in shape as long as a plane of incidence and an exit surface parallel to each other are provided.

The first transmissive optical part 13 is shown in FIG. 2 so as to be the same in size as the second transmissive optical part 14, but may instead have a side in the Y-axis direction shorter in length than a side in the X-axis direction and a side in the Z-axis direction since the first transmissive optical part 13 performs the scanning with the illumination light WL in the Z-axis direction but does not perform the scanning in the Y-axis direction as described later. That is, the first transmissive optical part 13 may have a rectangular parallelepiped shape having a side in the Y-axis direction shorter in length than a side in the X-axis direction and a side in the Z-axis direction instead of the shape approximate to the square parallelepiped shape shown in FIG. 2. Thus, a reduction in thickness of the first transmissive optical part 13 can be achieved. In that case, the second transmissive optical part 14 becomes larger in dimension than the first transmissive optical part 13, but a resin material can be used in the second transmissive optical part 14 as described above since the light density of the incident light is low. When the resin material is used as the glass material of the light transmissive members, since the second transmissive optical part 14 is reduced in weight, a reduction in size of the second rotating part 16 can be achieved.

At least one of the first transmissive optical part 13 and the second transmissive optical part 14 may be formed of quartz. In each of the first transmissive optical part 13 and the second transmissive optical part 14, the light intensity absorbed by the light transmissive member increases as the light intensity transmitted through the light transmissive member increases, and thermal strain is induced in the light transmissive member in some cases. In this case, the polarization direction of the illumination light WL emitted from the light source unit 10 is disturbed, and the linearly polarized light incident on the light transmissive member is converted into elliptically polarized light and is then emitted from the light transmissive member. As a result, it becomes unachievable to obtain the advantage that by using the laser diode for each of the light source units 101, 102, and 103 in the projector 200, predetermined contrast can be obtained without providing the incident side polarization plate. That is, although laser diodes are used for the light source units 101, 102, and 103, there arises a necessity of using the incident side polarization plate for uniformizing the polarization directions. Therefore, in order to obtain the advantage described above, it is desirable to use a glass material low in Young's modulus and thermal expansion coefficient as the glass material small in thermal strain, and as an example, it is desirable to use quartz.

The behavior of the illumination light WL when being transmitted through the first transmissive optical part 13 and the second transmissive optical part 14 will hereinafter be described. Note that since the first transmissive optical part 13 and the second transmissive optical part 14 are substantially the same in function, but are different only in direction from each other, the first transmissive optical part 13 will hereinafter be illustrated and described alone.

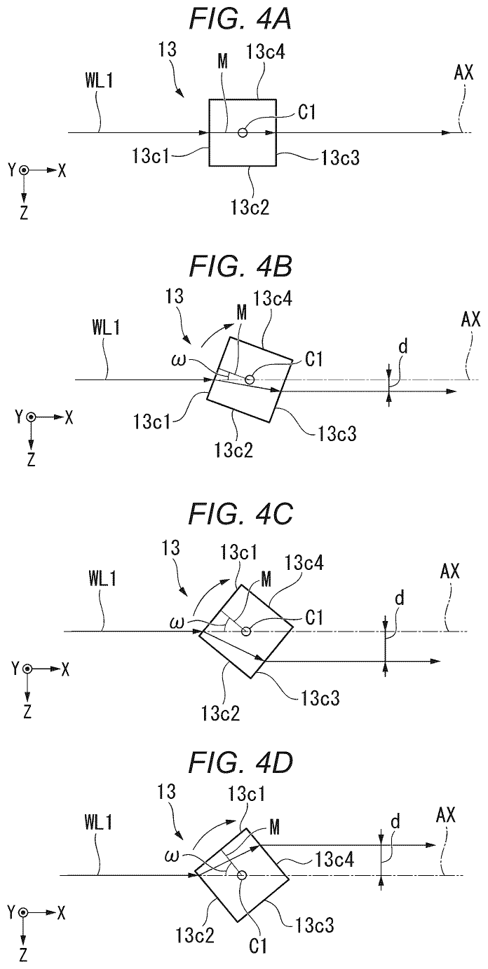

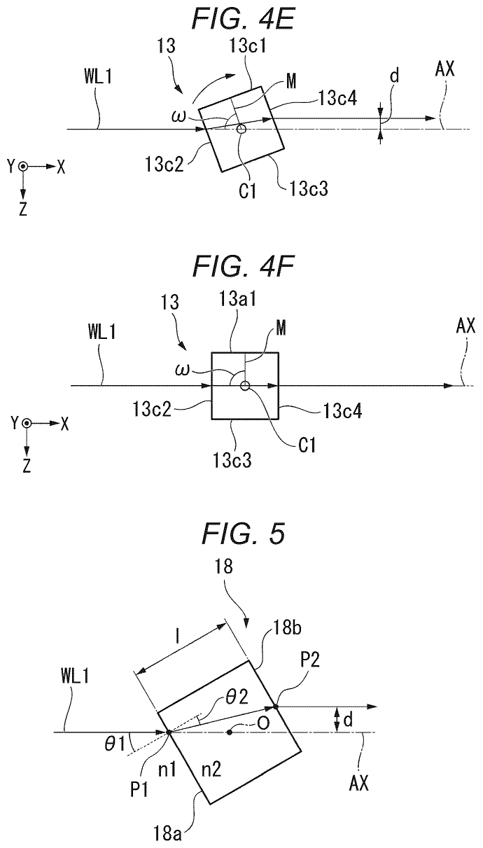

FIGS. 4A to 4F are schematic diagrams illustrating the behavior of the illumination light WL when the first transmissive optical part 13 rotates. In this example, the first transmissive optical part 13 rotates clockwise around the first rotational axis C1 when viewed from the +Y side, and in the drawings, time elapses from the state shown in FIG. 4A toward the state shown in FIG. 4F.

In FIGS. 4A to 4F, the angle between the optical axis AX and a straight line M, which passes through the first rotational axis C1 and is perpendicular to the first side surface 13c1 of the first transmissive optical part 13, is defined as a rotation angle ω of the first transmissive optical part 13. Further, although the illumination light WL actually has a predetermined light flux width in the Z-axis direction, consideration will be made here focusing attention on the behavior of the light beam WL1 as a principal ray of the illumination light WL propagating on the optical axis AX.

FIG. 4A shows an initial state of the first transmissive optical part 13. That is, the first transmissive optical part 13 is not rotating, the straight line M overlaps the optical axis AX, and the rotation angle ω is 0 degree. In this case, since the light beam WL1 is incident on the first side surface 13c1 at right angle, the light beam WL1 is not refracted at the first side surface 13c1 but travels inside the first transmissive optical part 13 along the optical axis AX. Then, the light beam WL1 is also incident on the first side surface 13c3, which is parallel to the first side surface 13c1, at right angle. Therefore, the light beam WL1 is not refracted at the first side surface 13c3, but is emitted from the first transmissive optical part 13, and then travels on the optical axis AX.

Then, as shown in FIG. 4B, when the first transmissive optical part 13 rotates by the rotation angle ω, the light beam WL1 is incident on the first side surface 13c1 at the incidence angle equal to the rotation angle ω. The light beam WL1 is therefore refracted in the direction (+Z side) shown in the drawing and then travels inside the first transmissive optical part 13. Since the light beam WL1 is then incident on the first side surface 13c3 at a predetermined incidence angle, the light beam WL1 is refracted at the first side surface 13c3 and is then emitted from the first transmissive optical part 13. On this occasion, since the first side surface 13c1 and the first side surface 13c3 are parallel to each other, the incidence angle of the light beam WL1 incident on the first side surface 13c1 and the incidence angle of the light beam WL1 incident on the first side surface 13c3 are equal to each other, and the refraction angle of the light beam WL1 incident on the first side surface 13c1 and the refraction angle of the light beam WL1 emitted from the first side surface 13c3 are opposite in sign and equal in absolute value. The refraction angle of the light beam WL1 incident on the first side surface 13c1 and the refraction angle of the light beam WL1 emitted from the first side surface 13c3 are canceled each other out. As a result, the light beam WL1 travels in parallel to the optical axis AX at a position displaced by a displacement amount d from the optical axis AX toward the +Z side.

Then, as shown in FIG. 4C, when the rotation angle ω of the first transmissive optical part 13 increases from the value shown in FIG. 4B, the incidence angle of the light beam WL1 increases and the refraction angle increases accordingly. Therefore, the displacement amount d of the light beam WL1 from the optical axis AX becomes larger than in FIG. 4B. Further, the state in which the light beam WL1 travels in parallel to the optical axis AX is constantly maintained. When the rotation angle ω is between 0 degree and 45 degrees, the displacement amount d monotonously increases as the rotation angle ω increases.

Then, as shown in FIG. 4D, when the rotation angle ω of the first transmissive optical part 13 exceeds 45 degrees, the plane of incidence of light beam WL1 changes from the first side surface 13c1 to the first side surface 13c2. On this occasion, the light beam WL1 is refracted at the first side surface 13c2, but the refraction direction changes from the direction during the period up to FIG. 4C, and the light beam WL1 is refracted in the direction (−Z side) shown in the drawing. Further, although the exit surface of the light beam WL1 also changes from the first side surface 13c3 to the first side surface 13c4, since the first side surface 13c2 and the first side surface 13c4 are parallel to each other, the situation in which the refraction angle of the light beam WL1 incident on the first side surface 13c3 and the refraction angle of the light beam WL1 emitted from the first side surface 13c4 are canceled each other out remains unchanged from the situation during the period up to FIG. 4C. As a result, the light beam WL1 travels in parallel to the optical axis AX at a position displaced by the displacement amount d from the optical axis AX toward the −Z side.

Then, as shown in FIG. 4E, when the rotation angle ω of the first transmissive optical part 13 becomes larger than in FIG. 4D, the incidence angle of the light beam WL1 decreases and the refraction angle decreases accordingly. Therefore, the displacement amount d of the light beam WL1 from the optical axis AX becomes smaller than in FIG. 4D. As described above, when the rotation angle ω is between 45 degrees and 90 degrees, the displacement amount d monotonously decreases as the rotation angle ω increases.

Then, as shown in FIG. 4F, when the rotation angle ω of the first transmissive optical part 13 reaches 90 degrees, the plane of incidence changes from the first side surface 13c1 as the initial state to the first side surface 13c2, but the behavior of the light beam WL1 is the same as that in the initial state shown in FIG. 4A.

As described above, when the first plane of incidence and the first exit surface of the first transmissive optical part 13 are parallel to each other, the traveling direction of the light beam WL1 does not change regardless of the rotation angle ω of the first transmissive optical part 13, and the light beam WL1 is translated in a direction parallel to the optical axis AX as the time elapses. When the rotation angle ω is 0 degree, the displacement amount d of the light beam WL1 is 0, and when the rotation angle ω is between 0 degree and 45 degrees, the displacement amount d increases toward either one of the +Z side and the −Z side. At the moment when the rotation angle ω exceeds 45 degrees, the displacement direction is reversed while keeping the absolute value of the displacement amount d the same, when the rotation angle ω is between 45 degrees and 90 degrees, the displacement amount d decreases, and when the rotation angle ω reaches 90 degrees, the displacement amount d becomes 0. After the rotation angle ω exceeds 90 degrees, the behavior described above is repeated. Therefore, when the first transmissive optical part 13 makes one revolution, the displacement amount d of the light beam WL1 repeats the cycle described above four times. The displacement amount of the light beam WL1 can be appropriately set by adjusting parameters such as the refractive index and the size of the first transmissive optical part 13.

The displacement in one direction due to the first transmissive optical part 13 has only been described above, but the light source device 1 includes the first transmissive optical part 13 and the second transmissive optical part 14 having rotational axes perpendicular to each other. Therefore, the illumination light WL is displaced in two directions perpendicular to each other as the time elapses. Specifically, as shown in FIG. 3, the first transmissive optical part 13 performs scanning with the illumination light WL emitted from the light source unit 10 in the Z-axis direction, and the second transmissive optical part 14 performs scanning in the Y-axis direction perpendicular to the Z-axis direction. That is, the first transmissive optical part 13 and the second transmissive optical part 14 scan the inside of a two-dimensional illumination target region Q in the illumination target surface, that is, each of the light modulation parts 30B, 30G, and 30R with the illumination light WL.

As shown in FIG. 1, the illumination light WL is incident on the magnifying optical system 2. The magnifying optical system 2 includes, for example, a concave lens 2a and a convex lens 2b. The magnifying optical system 2 magnifies the light flux diameter of the illumination light WL emitted from the light source device 1.

The illumination light WL having passed through the magnifying optical system 2 is incident on the color separation optical system 3.

The color separation optical system 3 separates the illumination light WL emitted from the light source device 1 into the red light LR, the green light LG, and the blue light LB, and guides them to the respective light modulation parts in the light modulation device 30.

The light modulation device 30 in the present embodiment includes a first light modulation part 30B, a second light modulation part 30G, a third light modulation part 30R, and half-wave plates 33B, 33R.

The color separation optical system 3 includes a first dichroic mirror 7a, a second dichroic mirror 7b, a first total reflection mirror 8a, a second total reflection mirror 8b, and a third total reflection mirror 8c.

The first dichroic mirror 7a separates the illumination light WL from the light source device 1 into the blue light LB and light including the green light LG and the red light LR. The first dichroic mirror 7a transmits the blue light LB and reflects the light including the green light LG and the red light LR. Meanwhile, the second dichroic mirror 7b reflects the green light LG and transmits the red light LR. Accordingly, the second dichroic mirror 7b separates the light including the green light LG and the red light LR into the green light LG and the red light LR.

The first total reflection mirror 8a is disposed in a light path of the blue light LB, and reflects the blue light LB transmitted through the first dichroic mirror 7a, toward the first light modulation part 30B. Meanwhile, the second total reflection mirror 8b and the third total reflection mirror 8c are disposed in a light path of the red light LR, and guide the red light LR transmitted through the second dichroic mirror 7b, to the third light modulation part 30R. The green light LG is reflected from the second dichroic mirror 7b toward the second light modulation part 30G.

The first light modulation part 30B includes a light modulation panel 31B and an exit-side polarization plate 32B.

The second light modulation part 30G includes a light modulation panel 31G and an exit-side polarization plate 32G.

The third light modulation part 30R includes a light modulation panel 31R and an exit-side polarization plate 32R.

A transmissive liquid crystal panel is used for each of the light modulation panels 31B, 31G, and 31R. A twisted nematic (TN) method, a vertical alignment (VA) method, an in-plane switching (IPS) method, and so on may be used as a method of driving the liquid crystal panels, but the method is not particularly limited. The drive of each of the light modulation panels 31B, 31G, and 31R of the light modulation parts 30B, 30G, and 30R is controlled by the control device CONT electrically coupled thereto.

Each of the exit-side polarization plates 32B, 32G, and 32R transmits linearly-polarized light in a specific direction. In the case of the present embodiment, the light source units 101, 102, and 103 of the light source device 1 emit laser beams as the blue light LB, the green light LG, and the red light LR, and therefore, it is possible to omit a light incident side polarization plate of each of the light modulation parts 30B, 30G, and 30R.

The blue light LB is temporally superimposed by two-dimensionally scanning the image forming region of the first light modulation part 30B with the blue light LB. The first light modulation part 30B modulates the blue light LB based on, for example, blue image information (first image information) input from an external device to the control device CONT to form blue image light (first image light) B.

The green light LG is temporally superimposed by two-dimensionally scanning the image forming region of the second light modulation part 30G with the green light LG. The second light modulation part 30G modulates the green light LG based on, for example, green image information (second image information) input from an external device to the control device CONT to form green image light (second image light) G.

The red light LR is temporally superimposed by two-dimensionally scanning the image forming region of the third light modulation part 30R with the red light LR. The third light modulation part 30R modulates the red light LR based on, for example, red image information (third image information) input from an external device to the control device CONT to form red image light (third image light) R.

Upon incidence of the image light emitted from the first light modulation part 30B, the image light emitted from the second light modulation part 30G, and the image light emitted from the third light modulation part 30R, the image light combining part 24 combines the image light corresponding to the blue light LB, the image light corresponding to the green light LG, and the image light corresponding to the red light LR with each other to output the image light thus combined toward the projection optical device 23. As the image light combining part 24, there is used, for example, a cross dichroic prism.

The half-wave plates 33B, 33R are disposed between the first light modulation part 30B and the image light combining part 24 and between the third light modulation part 30R and the image light combining part 24, respectively. The half-wave plates 33B, 33R apply a phase difference of a half wavelength to the incident colored light to rotate the polarization direction of the linearly-polarized light by 90 degrees. This makes it possible to make the polarization direction of the green light LG incident on the image light combining part 24 different from the polarization direction of the blue light LB and the red light LR incident on the image light combining part 24. According to this configuration, the light use efficiency of the image light combining part 24 can be increased.

The projection optical device 23 is formed of a plurality of projection lenses. The projection optical device 23 projects the image light emitted from the image light combining part 24 toward a projection target surface such as a screen in an enlarged manner. Thus, an image is displayed on the projection target surface.

When the light modulation part is temporally scanned with the light transmitted through the transmissive optical part rotating as described above, unevenness usually occurs in the illuminance distribution formed on the light modulation part. The present inventors performed a simulation in order to examine how various parameters such as the refractive index and shape of the transmissive optical part affect the illuminance distribution in the illumination target region. The simulation results will be described below.

FIG. 5 is a schematic diagram showing a transmissive optical part 18 serving as a model of the simulation. In the transmissive optical part, it is sufficient for the cross-sectional shape perpendicular to the rotational axis to be a regular n-gon (n is an even number no smaller than 4), but in FIG. 5, the cross-sectional shape of the transmissive optical part 18 is assumed as a square (n=4). Further, a distance between surfaces opposed to each other of the transmissive optical part 18 is denoted by I, a refractive index of an external space of the transmissive optical part 18 is denoted by n1, and a refractive index of the transmissive optical part 18 is denoted by n2.

As illustrated in FIG. 5, an optical axis AX of a light source unit (not shown) that emits the light beam WL1 toward the transmissive optical part 18 passes through the center of the rotational axis O of the transmissive optical part 18. The light beam WL1 travels in parallel to the optical axis AX, enters a first plane of incidence 18a of the transmissive optical part 18 at an incidence angle θ1 at a point P1, and is refracted at a refractive angle θ2, and is then emitted from a first exit surface 18b of the transmissive optical part 18 at a point P2, and travels in parallel to the optical axis AX.

The light beam WL1 transmitted through the transmissive optical part 18 which is rotating travels in parallel to the optical axis AX at a position shifted by the displacement amount d corresponding to the rotation angle of the transmissive optical part 18 in a direction orthogonal to (crossing) the optical axis AX. Therefore, Formula (1) described below is established between the displacement amount d, the incidence angle θ1, and the refraction angle θ2 of the light beam WL1 based on Snell's law.

$$\begin{matrix}d = l ( tan {θ}_{1} - tan {θ}_{2} ) \cdot cos {θ}_{1} \\ = l [ tan {θ}_{1} - tan \{ {sin}^{- 1} ( \frac{{n}_{1}}{{n}_{2}} sin {θ}_{i} ) \} ] cos {θ}_{1}\end{matrix} \qquad ( 1 )$$

Further, the maximum incidence angle θmax of the light beam WL1 in the transmissive optical part 18 is expressed by Formula (2) described below.

$$\vert {θ}_{max} \vert = \frac{180}{n} \qquad ( 2 )$$

Here, for example, regrading Formula (1), when it is assumed that the distance 1 between the surfaces opposed to each other of the transmissive optical part 18 is 20 mm, the refractive index n1 of the external space is n1=1.0 (air), the rotation angle (degree) is plotted on the horizontal axis, the displacement amount (mm) is plotted on the vertical axis, and the refractive index n2 of the transmissive optical part 18 is plotted at an appropriate interval from 1.3 to 1000, the relationship between the rotation angle and the displacement amount can be expressed by a periodic function. Further, when the refractive index n2 of the transmissive optical part 18 is increased toward infinity with respect to this periodic function, the relationship between the rotational angle and the displacement amount can be defined by an ideal sine wave with the amplitude I.

Since the rotation angle of the transmissive optical part 18 is equal to the incidence angle θ1, it is sufficient for the rotation angle of the transmissive optical part 18 to be considered within a range of the maximum incidence angle θmax of the light beam WL1 as a result. Further, the maximum incidence angle θmax of the transmissive optical part 18 is determined in accordance with the cross-sectional shape as expressed by Formula (2). That is, when the cross-sectional shape of the transmissive optical part 18 is a square as shown in FIG. 5, the maximum incidence angle θmax is maximized (to 45 degrees).

Therefore, when the light beam WL1 traveling on the optical axis AX passing through the rotation center of the transmissive optical part 18 is displaced in a direction perpendicular to the optical axis AX by being transmitted through the transmissive optical part 18, it is thought to be sufficient to consider within an angle range of ±45 degrees with respect to the periodic function representing the relationship between the rotation angle and the displacement amount of the transmissive optical part 18 having a square shape.

The present inventors focus attention on the point that the uniformity of the illuminance distribution of light in the illumination target region can be improved as the linearity of the graph increases.

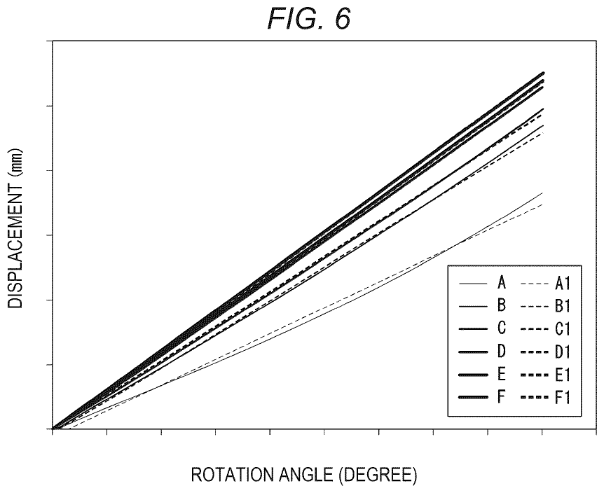

FIG. 6 is a graph showing a relationship between the rotation angle and the displacement amount of the transmissive optical part 18 having a square shape. In FIG. 6, the horizontal axis represents the rotation angle (degree), and the vertical axis represents the displacement amount (mm). The graph with a reference symbol A shows when the refractive index n2 is 1.63. The graph with a reference symbol B shows when the refractive index n2 is 2.22. The graph with a reference symbol C shows when the refractive index n2 is 2.46. The graph with a reference symbol D shows when the refractive index n2 is 2.91. The graph with a reference symbol E shows when the refractive index n2 is 3.05. The graph with a reference symbol F shows when the refractive index n2 is 3.27.

Note that in FIG. 6, the solid lines denoted by the reference symbols A to F are graphs representing the periodic function representing the relationship between the rotation angle and the displacement amount of the transmissive optical part 18 in an angle range of 0 degree to 45 degrees, and the broken lines denoted by the reference symbols A1 to F1 are graphs showing linear approximations of the periodic functions denoted by the reference symbols A to F.

As shown in FIG. 6, it can be confirmed that the linearity of the graph increases as the refractive index n2 of the transmissive optical part 18 increases. That is, when the cross-sectional shape of the transmissive optical part 18 is a square, the linearity of the graph increases as the refractive index increases, and the uniformity of the illuminance distribution of the light in the illumination target region can be improved. For example, when the refractive index of the transmissive optical part 18 is set to 2.91, the solid line and the broken line overlap each other, and therefore, the linearity of the graph becomes sufficiently high, and thus, the uniformity of the illuminance distribution of the light in the illumination target region can sufficiently be improved.

In contrast, it is poor in implementation at this stage to form the transmissive optical part 18 with a material having a refractive index of 3.0 or higher, and there is a limit in improving the uniformity of the illuminance distribution by devising the material of the transmissive optical part 18.

In this regard, the present inventors have found that the refractive index necessary for increasing the linearity of the graph differs depending on the shape of the transmissive optical part.

A relationship between the refractive index of the transmissive optical part and the shape (regular n-gon) of the transmissive optical part is shown in Table 1. Note that in Table 1, air (refractive index: 1.0) was assumed as the medium outside the transmissive optical part. Further, in Table 1, the determination coefficient, which is the square value (denoted by R2) of the correlation coefficient, is set to 0.995 or more in the approximate expression. Note that in Table 1, “-” means that the material is not limited as long as the refractive index is higher than 1.0.

TABLE 1

| REGULAR | R2 | | | | | |
|---|---|---|---|---|---|---|
| n-GON | 0.995 | 0.999 | 0.9995 | 0.9999 | 0.99995 | 0.99999 |
| n = 4 | 1.63 | 2.22 | 2.46 | 2.91 | 3.05 | 3.27 |
| n = 6 | 1.14 | 1.69 | 1.96 | 2.57 | 2.80 | 3.20 |
| n = 8 | — | 1.30 | 1.54 | 2.18 | 2.45 | 2.99 |
| n = 10 | — | 1.03 | 1.24 | 1.83 | 2.11 | 2.73 |
| n = 12 | — | — | 1.02 | 1.55 | 1.83 | 2.48 |

As shown in Table 1, when the cross-sectional shape of the transmissive optical part 18 is a square (n=4), by setting the refractive index of the transmissive optical part 18 to be equal to or greater than 1.63, the determination coefficient of the graph representing the displacement amount becomes 0.995, and the linearity of the graph can be enhanced. In contrast, when the cross-sectional shape of the transmissive optical part is a regular hexagonal shape, the determination coefficient of the graph can be set to 0.995 by setting the refractive index of the transmissive optical part 18 to 1.14. Furthermore, by setting the refractive index to 2.80 when the cross-sectional shape is a regular hexagonal shape, the determination coefficient of the graph becomes 0.99995, and the linearity of the graph can sufficiently be increased. Accordingly, when adopting a regular hexagonal shape as the cross-sectional shape of the transmissive optical part, the linearity of the graph can be enhanced while suppressing the refractive index of the transmissive optical part 18 to a lower level compared to when adopting a square shape as the cross-sectional shape of the transmissive optical part.

As shown in Table 1 described above, the present inventors have found out that when the cross-sectional shape of the transmissive optical part is a regular octagon, a regular decagon, or a regular dodecagon, that is, a regular polygon having sides no less than those of an octagon, the linearity of the graph is sufficiently improved by setting the refractive index of the transmissive optical part within a general range such as 1 to 2.73. Therefore, when adopting a regular polygon having sides no less than those of an octagon as the cross-sectional shape of the transmissive optical part, the limitation of the refractive index in the transmissive optical part is reduced, and therefore, it is possible to broaden the room for choice of materials available for the transmissive optical part. This facilitates the optical design of the transmissive optical part.

Based on such a configuration, in the projector 200 according to the present embodiment, it is arranged that the uniformity of the illuminance distribution of the light with which each of the light modulation parts 30B, 30G, and 30R is two-dimensionally scanned is enhanced by appropriately selecting the materials of the first transmissive optical part 13 and the second transmissive optical part 14.

Further, the present inventors have focused attention on the fact that when scanning the image forming regions of the light modulation parts 30B, 30G, and 30R with light, for example, the light incident on a black display area in the image forming region is not emitted from the light modulation parts 30B, 30G, and 30R, and therefore the light source device 1 wastes the power. Then, the present inventors have completed the projector 200 according to the present embodiment which improves the power use efficiency of the light source device 1 by performing the light control to adjust the luminance of the light with which the image forming region of each of the light modulation parts 30B, 30G, and 30R is scanned.

The light control of the projector 200 according to the present embodiment will hereinafter be described.

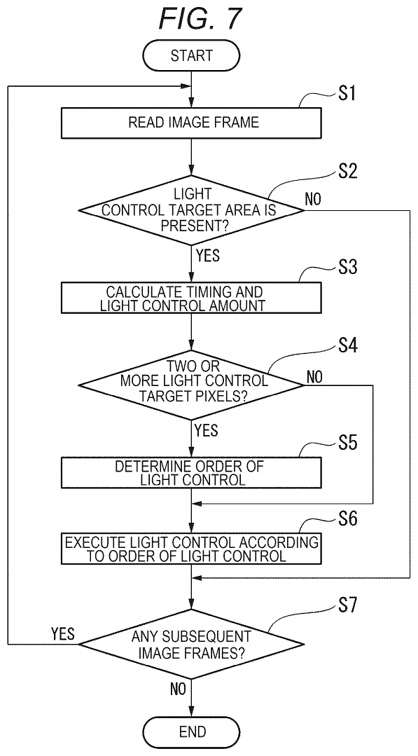

FIG. 7 is a flowchart showing a flow of processing of the light control.

As shown in FIG. 7, the control device CONT begins the light control processing at the start of the operation of the projector 200. In step S1, the control device CONT reads an image frame contained in the image information input from the outside. The image information is formed of a single image frame or a plurality of image frames in accordance with the type of an image to be displayed.

In step S2, the control device CONT determines whether the image frame thus read includes a light control target area.

The control device CONT determines whether the display image includes the light control target area based on the image information input from the outside. In the present specification, the light control target area means an area including a light control target pixel. The light control target pixel is a pixel that has a luminance value higher or lower than a light control reference value which is a threshold value for determining whether to perform the light control, and that is a target of the light control. In the present embodiment, there is described when a pixel (white display pixel) having a luminance value higher than the light control reference value (black display pixel) is determined as the light control target pixel.

Therefore, in step S2, the control device CONT in the present embodiment determines whether a plurality of pixels in the image forming region includes the light control target pixel.

Description will hereinafter be presented citing, as an example, when performing the light control on the blue light LB which is color-separated from the illumination light WL emitted from the light source device 1, and with which the image forming region of the first light modulation part 30B is scanned. Note that substantially the same way of thinking holds true for the method of adjusting the luminance of the green light LG with which the image forming region of the second light modulation part 30G is scanned and the luminance of the red light LR with which the image forming region of the third light modulation part 30R is scanned.

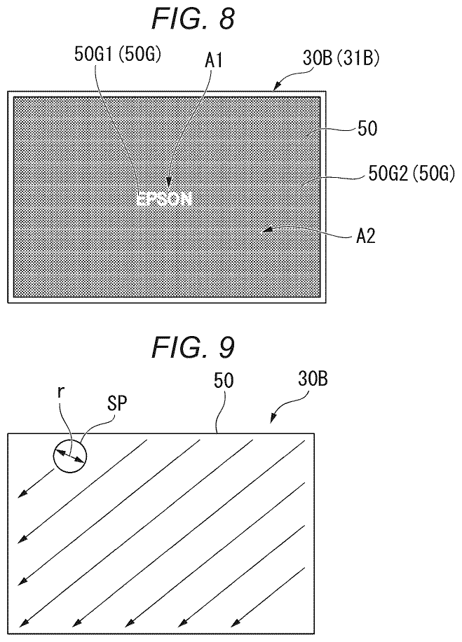

FIG. 8 is a diagram illustrating a configuration of an essential part of the image forming region 50 of the first light modulation part 30B.

As illustrated in FIG. 8, the first light modulation part 30B includes the image forming region 50 provided to the light modulation panel 31B. The image forming region 50 includes a plurality of pixels 50G. FIG. 8 is an image diagram when an image for displaying characters “EPSON” on the background with black display is formed on the image forming region 50.

Note that the image forming regions of the second light modulation part 30G and the third light modulation part 30R each have substantially the same configuration as that of the image forming region 50 of the first light modulation part 30B.

The image forming region 50 includes a first region A1 constituting a character of “EPSON” and a second region A2 constituting the background with black display. Hereinafter, the pixels 50G constituting the first region A1 are referred to as first pixels 50G1, and the pixels 50G constituting the second region A2 are referred to as second pixels 50G2.

FIG. 9 is an image diagram showing a locus of the blue light LB with which the image forming region 50 of the first light modulation part 30B is scanned.

As shown in FIG. 9, the blue light LB forms a spot SP having a substantially circular shape on the image forming region 50. The spot SP of the blue light LB is moved in scanning so as to draw, for example, a plurality of trajectories obliquely extending from the upper right toward the lower left in the drawing. The trajectory drawn by the spot SP of the blue light LB on the image forming region 50 may hereinafter be referred to as a scanning line in some cases.

Note that the uniformity of the illuminance distribution in the image forming region 50 and the resolution of the light control area are improved as the radius of the spot SP of the blue light LB decreases, or as the number of scanning lines that scan the image forming region 50 increases.

Note that decreasing the radius r of the spot SP of the blue light LB means that the radius r becomes relatively small with respect to the image forming region 50 on the first light modulation part 30B, and for example, the radius r of the spot SP may be decreased by increasing the size of the light modulation part.

The first pixels 50G1 are pixels for displaying characters, and are therefore required to transmit the blue light LB. On the other hand, the second pixels 50G2 are pixels for black display, and are therefore not required to transmit the blue light LB. When the blue light LB is supposedly incident on both the first pixels 50G1 and the second pixels 50G2, the blue light LB incident on the second pixels 50G2 is blocked by the exit-side polarization plate 32B in the posterior stage of the second pixels 50G2, and therefore, the blue light LB incident on the second pixels 50G2 results in loss.

The control device CONT handles the first region A1 of the image forming region 50 as the “light control target area,” and the first pixels 50G1 in the first region A1 as the “light control target pixels.”

That is, when the image shown in FIG. 8 is displayed in the image forming region 50, the control device CONT determines in step S2 that the plurality of pixels in the image forming region includes the light control target pixel (YES in step S2), and proceeds to step S3 illustrated in FIG. 7. In step S3, the control device CONT calculates the timing and a light control amount of the light control.

Note that when it is determined in step S2 that the image frame thus read does not include the light control target area (NO in step S2), the control device CONT proceeds to step S7 described later.

Specific processing in step S3 will hereinafter be described with reference to the drawings.

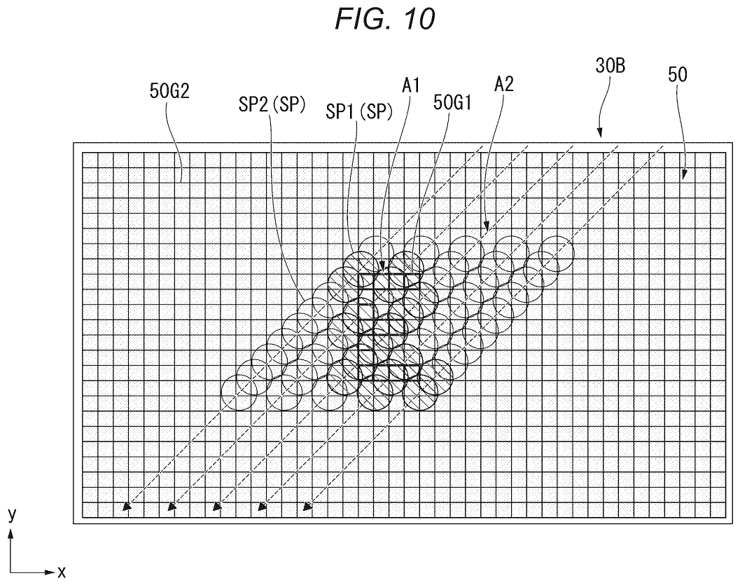

FIG. 10 is a diagram illustrating the light control when displaying the characters shown in FIG. 8. In FIG. 10, only “E” out of the characters “EPSON” to be displayed on the image forming region 50 is shown in an enlarged manner in order to facilitate viewing of the drawing. Note that in FIG. 10, a solid line represents the spot SP formed on the image forming region 50 when the blue light LB is actually emitted, and a broken line represents a virtual spot SP formed on the image forming region 50 when the blue light LB is assumed to be supposedly incident when the blue light LB is not emitted. Hereinafter, the spot SP represented by the solid line may be referred to as an actual spot SP1, and the spot SP represented by the broken line may be referred to as a virtual spot SP2 in some cases.

As shown in FIG. 10, the spot SP of the blue light LB is obliquely moved in scanning from the upper right toward the lower left in the drawing on the image forming region 50. The spot SP of the blue light LB passes through the first pixel 50G1 or the second pixel 50G2 described above on the image forming region 50.

Hereinafter, when describing the positional relationship on the image forming region 50, an x-y coordinate system is set on the image forming region 50. Further, a direction along the left and right sides of the image forming region 50 illustrated in FIG. 10 is referred to as a left-right direction x, and a direction along the upper and lower sides of the image forming region 50 is referred to as an up-down direction y.

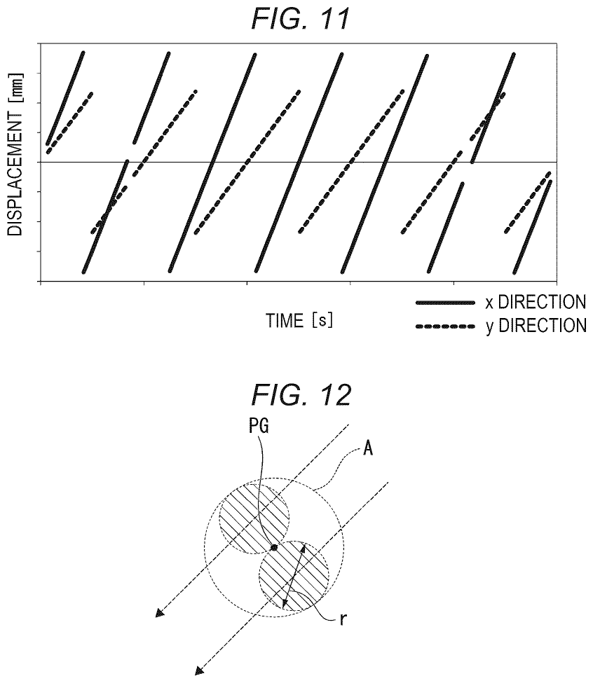

FIG. 11 is a diagram showing a displacement of the spot SP of the blue light LB due to the rotations of the first transmissive optical part 13 and the second transmissive optical part 14. In FIG. 11, the horizontal axis represents time (s), and the vertical axis represents displacement (mm). In FIG. 11, displacement amounts in the x direction and the y direction of the blue light LB in the image forming region 50 are shown, a portion represented by a straight line corresponds to a period in which the blue light LB is emitted, and a portion in which the straight line is broken corresponds to a period in which the blue light LB is not emitted.

As shown in FIG. 10, at the timing when the actual spot SP1 of the blue light LB passes through the first pixel 50G1, the control device CONT turns ON the first light source unit 101 with the first light source drive unit CON1 illustrated in FIG. 2 so as to emit the blue light LB in a period corresponding to the portion represented by the straight line in FIG. 11. Thus, as shown in FIG. 10, the blue light LB irradiates the first pixel 50G1.

As shown in FIG. 10, at the timing when the virtual spot SP2 of the blue light LB passes through the second pixel 50G2, the control device CONT turns OFF the first light source unit 101 with the first light source drive unit CON1 illustrated in FIG. 2 so as to put off the blue light LB in a period corresponding to the broken portion of the straight line in FIG. 11. Accordingly, as shown in FIG. 10, the second pixel 50G2 is not irradiated with the blue light LB.

In this manner, the control device CONT can suppress the loss of the power consumption of the light source unit 10 by performing the light control of adjusting the luminance of the blue light LB so that the blue light LB is put on in accordance with the timing at which the blue light LB is transmitted through the first pixel 50G1 and the blue light LB is put OFF in accordance with the timing at which the blue light LB is transmitted through the second pixel 50G2.

The timing in the light control will hereinafter be described more specifically.

Here, defining the incidence angle of the blue light LB with respect to the first transmissive optical part 13 that is in charge of the displacement in the left-right direction x on the image forming region 50 as θx(t), θx(t) becomes a saw-tooth wave having an amplitude θmax and a period T. Therefore, when θx(t) is applied to a general formula of saw-tooth waves, Formula (3) described below is established.

$${θ}_{x} ( t ) = 2 {θ}_{x max} \{ \frac{t}{T} - floor ( \frac{t}{T} + 0.5 ) \} \qquad ( 3 )$$

Here, floor(x) is a floor function for the real number x, and is defined as a maximum integer no greater then x.

Since the incidence angle θx(t) of the blue light LB to the first transmissive optical part 13 is expressed by Formula (1) described above, the displacement amount dx(t) in the x-axis direction of the blue light LB on the image forming region 50 of the first light modulation part 30B is expressed by Formula (4) described below.

$$dx = l [ tan {θ}_{x} ( t ) - tan \{ {sin}^{- 1} ( \frac{{n}_{1}}{{n}_{2}} sin {θ}_{x} ( i ) ) \} ] cos {θ}_{x} ( t ) \qquad ( 4 )$$

Note that the incidence angle of the blue light LB with respect to the second transmissive optical part 14 in charge of the displacement in the up-down direction y on the image forming region 50 is expressed by substantially the same formula as Formula (3) described above, and the displacement amount dy(t) in the y-axis direction of the blue light LB on the first light modulation part 30B is expressed by a similar formula obtained by replacing x in Formula (4) with y.

Here, a position coordinate of the first pixel 50G1 in the image forming region 50 is defined as (px, py), a radius in the scanning direction of the blue light LB on the image forming region 50 is defined as r, and a position coordinate of the blue light LB on the image forming region 50 at the time t is defined as (dx(t), dy(t)).

On this occasion, the control device CONT increases the output of the first light source unit 101 at a timing which satisfies Formula (5) described below. Specifically, in the present embodiment, the control device CONT changes the first light source unit 101 from an OFF state to an ON state to thereby control the light intensity of the blue light LB incident on the first pixel 50G1 to increase. In the case of the present embodiment, the control device CONT sets the light control amount of the first light source unit 101 such that luminance of the blue light LB becomes, for example, about 80% of the maximum luminance.

$$\sqrt{{\{ {p}_{x} - {d}_{x} ( t ) \}}^{2} + {\{ {p}_{y} - {d}_{y} ( t ) \}}^{2}} ≦ r \qquad ( 5 )$$

Formula (5) described above means that the position coordinate of the first pixel 50G1 is located within the radius r of the blue light LB. That is, the timing represented by Formula (5) means the timing at which the actual spot SP1 of the blue light LB overlaps at least a part of the first pixel 50G1 as shown in FIG. 10.

After calculating the timing and the light control amount of the light control in step S3, the control device CONT proceeds to step S4.

In step S4, the control device CONT determines whether there are two or more light control target pixels. That is, the control device CONT calculates the number of first pixels 50G1 located within the first region A1 of the image forming region 50.

When there are two or more first pixels 50G1 (YES in step S4), the control device CONT proceeds to step S5.

In step S5, the control device CONT determines the order of performing the light control on the two or more first pixels 50G1. Specifically, the control device CONT rearranges the order in which the light control of each first pixel 50G1 is performed to the order in which the blue light LB, with which the image forming region 50 is scanned, passes through the first pixels 50G1, and then proceeds to step S6.

In step S6, the control device CONT performs the light control of turning ON the first light source unit 101 for emitting the blue light LB at the timing at which the blue light LB overlaps each first pixel 50G1 in accordance with the order of the light control set in step S5, and then proceeds to step S7.

Note that when the number of first pixels 50G1 is one (No in step S4), the control device CONT skips step S5 to proceed to step S6 to perform the light control of turning ON the first light source unit 101 for emitting the blue light LB at the timing at which the blue light LB overlaps the one first pixel 50G1, and then proceeds to step S7.

In step S7, the control device CONT determines whether there are any subsequent image frames. When there is a subsequent image frame (YES in step S7), the control device CONT returns to step S1 and repeats step S1 to step S6 described above. That is, when the image information includes a plurality of image frames, the control device CONT performs the light control by repeating the processing described above every time each image frame is read. Specifically, the light control for the first pixel 50G1 contained in the image frame to be performed every time the image frame is read in sequence is performed by the control device CONT on all the image frames. Then, after completing the processing for all the image frames, the control device CONT terminates the light control.

Note that in the light control of the green light LG and the red light LR incident on the second light modulation part 30G and the third light modulation part 30R, the control device CONT performs substantially the same processing as in the light control of the blue light LB incident on the first light modulation part 30B.

In this way, the control device CONT controls the output of the first light source unit 101 so as to adjust the light intensity of the blue light LB incident on the light control target pixels of the first light modulation part 30B based on the blue image information, controls the output of the second light source unit 102 to adjust the light intensity of the green light LG incident on the light control target pixels of the second light modulation part 30G based on the green image information, and controls the output of the third light source unit 103 to adjust the light intensity of the red light LR incident on the light control target pixels of the third light modulation part 30R based on the red image information.

Note that the light modulation parts 30B, 30G, and 30R may adjust the degree of modulation of the image forming regions based on the luminance of the colored light LB, LG, and LR that have been subjected to the light control, respectively. Accordingly, it is possible to generate the image light with a desired color tone, and thus, it is possible to display an image higher in quality.

As described above, the projector 200 according to the present embodiment includes the light source unit 10 that emits the illumination light WL, the first transmissive optical part 13 including the first plane of incidence on which the illumination light WL emitted from the light source unit 10 is incident and the first exit surface that reflects the light incident from the first plane of incidence, the first rotating part 15 that rotates the first transmissive optical part 13, the light modulation device 30 that modulates the illumination light WL emitted from the first transmissive optical part 13 based on the image information to generate the image light, and the control device CONT that controls the output of the light source unit 10. The light modulation device 30 includes the image forming region 50 including the plurality of pixels 50G. The first transmissive optical part 13 is a light transmissive member having the first plane of incidence and the first exit surface parallel to each other, and rotates around the first rotational axis C1 extending along the Y-axis direction crossing the X-axis direction as the incident direction of the illumination light WL with respect to the first transmissive optical part 13 to thereby scan the image forming region 50 of the light modulation device 30 with the illumination light WL emitted from the light source unit 10. The control device CONT selects the first pixel 50G1 from among the plurality of pixels 50G based on the image information, and performs the light control of adjusting the light intensity of the illumination light WL incident on the first pixel 50G1 by decreasing the output of the light source unit 10 when the luminance value corresponding to the first pixel 50G1 in the image light is smaller than the light control reference value at the timing which satisfies the following formula when defining the position coordinate of the first pixel 50G1 in the image forming region 50 as (px, py), the radius in the scanning direction of the illumination light WL in the image forming region 50 as r, and the position coordinate of the illumination light WL on the image forming region 50 at the time t as (dx(t), dy(t)).

$$\sqrt{{\{ {p}_{x} - {d}_{x} ( t ) \}}^{2} + {\{ {p}_{y} - {d}_{y} ( t ) \}}^{2}} ≦ r$$

According to the projector 200 of the present embodiment, since the control device CONT performs the light control on the colored light LB, LG, and LR emitted from the respective light source units 101, 102, and 103 toward the first pixels 50G1 based on the image information, the light intensity blocked by the exit-side polarization plates 32B, 32G, and 32R disposed at the posterior stage of the light modulation parts 30B, 30G, and 30R can be reduced. Accordingly, the light use efficiency of the colored light LB, LG, and LR emitted from the light source units 101, 102, and 103 can be improved.

Therefore, according to the projector 200 of the present embodiment, it is possible to realize a projector which achieves the lower power consumption of the light source units 101, 102, and 103, and which is excellent in display quality.

Further, since the light intensity absorbed by the exit-side polarization plates 32B, 32G, and 32R is reduced, the loads of the exit-side polarization plates 32B, 32G, and 32R can be reduced. This makes it possible to expect the advantages such as an improvement of the reliability of the exit-side polarization plates 32B, 32G, and 32R, and an improvement of the contrast by adopting the polarization plates made of an organic material.

Further, according to the projector 200 of the present embodiment, the image forming regions 50 of the light modulation parts 30B, 30G, and 30R can be illuminated in a substantially rectangular shape without using an optical system for shaping the light into a rectangular shape, such as a multi-lens. Therefore, the total optical path length can be relatively shortened, and the number of interfaces between the optical system and the air can be reduced by reducing the number of optical components, and therefore, it is possible to reduce the loss of light due to the interfacial reflection.

Note that in the present embodiment, there is cited when the light transmissive members having a square shape are used as the first transmissive optical part 13 and the second transmissive optical part 14 as an example, but the transmissive optical parts having the cross-sectional shape of a regular polygon no smaller in the number of sides than a regular octagon, that is a regular polygon the number of sides of which is an even number no smaller than 8 may be used as the first transmissive optical part 13 and the second transmissive optical part 14. According to this configuration, even when a material having an ordinary refractive index is used as the light transmissive member, the linearity of the displacement amount of the colored light LB, LG, and LR can be enhanced, and therefore, the uniformity of the illuminance distribution in the image forming regions 50 of each of the light modulation parts 30B, 30G, and 30R can more easily and conveniently be improved.

### First Modified Example

As shown in FIG. 2, the control device CONT may include an image processing unit CON0. The image processing unit CON0 performs predetermined image processing on the image information input from the outside. The image processing unit CON0 performs image processing for correcting the image information input from the outside into, for example, information compatible with a display mode selected by the user.

Examples of the display mode include a “dynamic mode” suitable for viewing in a bright environment, a “living mode” suitable for viewing in a thin light, a “natural mode” capable of reproducing an image faithful to an input signal in a dark environment, and a “theater mode” suitable for movie viewing in a dark environment. For example, the “dynamic mode” is a brightness emphasizing mode in which brightness of an image is more emphasized than a color tone of the image.

In this case, the control device CONT desirably calculates the light intensity of each colored light to be incident on the first pixel 50G1 of the image forming region 50 of each of the light modulation parts 30B, 30G, and 30R based on the image information on which the image processing by the image processing unit CON0 has been performed. According to this configuration, the control device CONT performs the light control of the colored light with which the image forming region 50 is scanned based on the image information compatible with the display mode, and therefore, it is possible to display the high-quality image more suitable for the display mode.

### Second Modified Example

In the first embodiment, there is cited when the light control reference value is set to the black display pixel, the light control target pixel is set to the white display pixel, and the light control is performed by turning ON the light source unit in accordance with the timing of passing on the light control target pixel as an example, but the present disclosure is not limited to this example. For example, the light control reference value may be set to the white display pixel, the light control target pixel may be set to the black display pixel, and the light control may be performed by turning OFF the light source unit in accordance with the timing of passing on the light control target pixel.

According to this configuration, since the light is not incident on the light control target pixel of the black display, it is possible to suppress the decrease in the light use efficiency in the light source unit caused by blocking the incident light in the light control target pixel.

It is assumed that, for example, the light control target pixel PG is present on the boundary between the scanning lines adjacent to each other in the incident light L as shown in FIG. 12 when turning OFF the light source unit 10 in accordance with the timing of passing on the light control target pixel. On this occasion, since light source unit 10 is turned OFF for the two spots adjacent to each other in the light control target pixels PG, the area twice as large as the radius r of the spot of the illumination light becomes the black display. Therefore, when performing the light control of turning OFF the light source unit 10 so as to prevent the light from entering the light control target pixel PG of the black display, the region overlapping the area twice (2r) as large as the radius r of the spot of the incident light L becomes the range A which is affected by the light control. In other words, in the case of the present modified example, the control device CONT can perform the light control when the entire range A of the maximum range 2r affected by the light control becomes the black display area. This is because when the range A affected by the light control includes the white display area, a display failure in the white display area occurs.

Further, the present disclosure is also applicable to when the light control reference value is set to an intermediate gradation level between the black display and the white display, and the pixel higher in luminance value than the intermediate gradation level is determined as the light control target pixel, or the pixel lower in luminance value than the intermediate gradation level is determined as the light control target pixel.

### Second Embodiment

A second embodiment of the present disclosure will hereinafter be described using the drawings.

The projector according to the present embodiment is different from the projector according to the first embodiment in that the first transmissive optical part 13 scans one light modulation part with the light from the light source unit. Note that the same reference numerals are given to constituents common to those in the first embodiment to omit the detailed description thereof.

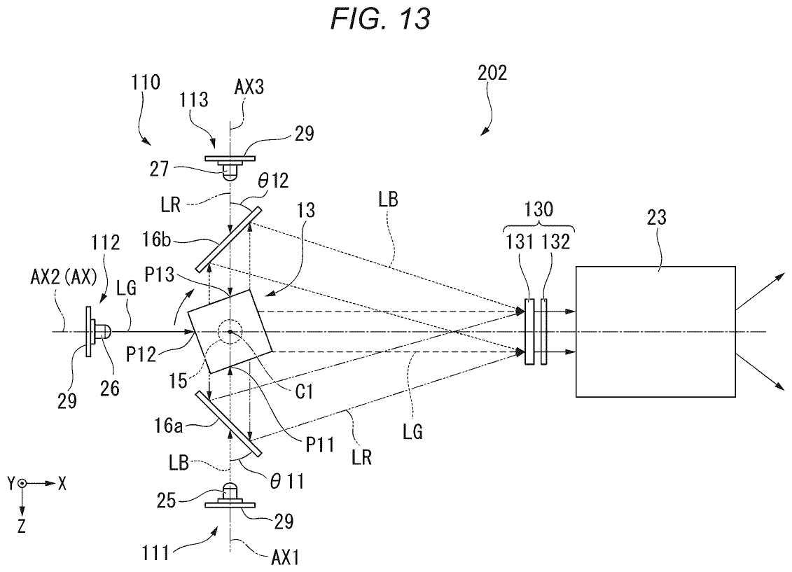

FIG. 13 is a plan view showing a schematic configuration of a projector 202 according to the present embodiment.

As illustrated in FIG. 13, the projector 202 according to the present embodiment includes a light source device 110, a light modulation device 130, and the projection optical device 23.

The light source device 110 in the present embodiment includes a first light source unit 111, a second light source unit 112, a third light source unit 113, the first transmissive optical part 13, the first rotating part 15, a first optical part 16a, and a second optical part 16b.

The first light source unit 111 outputs the blue light LB toward the first transmissive optical part 13 (−Z side). The second light source unit 112 outputs the green light LG toward the first transmissive optical part 13 (+X side). The third light source unit 113 outputs the red light LR toward the first transmissive optical part 13 (+Z side).

The optical axis AX1 of the first light source unit 111 and the optical axis AX3 of the third light source unit 113 are located on the same axis. The optical axis AX2 of the second light source unit 112 is orthogonal to the optical axis AX1 of the first light source unit 111 and the optical axis AX3 of the third light source unit 113, and coincides with the optical axis AX of the light source device 110. According to this configuration, for example, when each light source unit includes a cooling member such as a heatsink, the cooling member and a flow path of the cooling air do not need to be obliquely disposed. This makes it possible to increase the degree of freedom of the layout of the components constituting the projector 202, and to reduce the size of the projector 202.

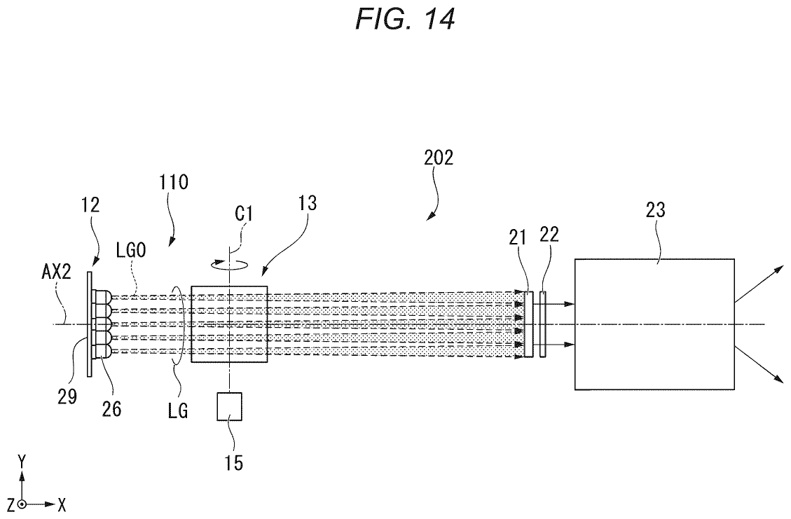

The basic configurations of the light source units 111, 112, and 113 are substantially the same, and a specific configuration of the second light source unit 112 will hereinafter be described using FIG. 14. In FIG. 14, illustration of the first light source unit 111, the third light source unit 113, the first optical part 16a, the second optical part 16b, and the like is omitted.

As illustrated in FIG. 14, the second light source unit 112 includes a plurality of second light emitting parts 26 and the substrate 29. The plurality of second light emitting parts 26 is arranged in a single line at predetermined intervals along the Y-axis direction. In the present embodiment, the second light source unit 112 includes five second light emitting parts 26, but the number of second light emitting parts 26 is not particularly limited as long as the plurality of second light emitting parts 26 is arranged in a single line along the Y-axis direction.

Based on such a configuration, the green light LG emitted from the second light source unit 112 is formed of a light flux including a plurality of light beams LGO arranged along the Y-axis direction, and therefore has a strip shape including a long axis extending along the Y-axis direction and a short axis extending along the Z-axis direction.

Similarly, the first light source unit 111 includes a plurality of first light emitting parts 25 and the substrate 29. The plurality of first light emitting parts 25 is arranged in a single line at predetermined intervals along the Y-axis direction. The third light source unit 113 includes a plurality of third light emitting parts 27 and the substrate 29. The plurality of third light emitting parts 27 is arranged in a single line at predetermined intervals along the Y-axis direction.

Based on such a configuration, the blue light LB emitted from the first light source unit 111 is formed of a light flux including a plurality of light beams arranged along the Y-axis direction, and therefore has a strip shape including a long axis extending along the Y-axis direction and a short axis extending along the X-axis direction. Further, the red light LR emitted from the third light source unit 113 is formed of a light flux including a plurality of light beams arranged along the Y-axis direction, and therefore has a strip shape including a long axis extending along the Y-axis direction and a short axis extending along the X-axis direction.

As illustrated in FIG. 13, the first transmissive optical part 13 is provided at a position where the optical axis AX1 and the optical axis AX3 cross the optical axis AX2. The first transmissive optical part 13 rotates about the first rotational axis C1 by the drive of the first rotating part 15.

The first transmissive optical part 13 transmits each of the blue light LB, the green light LG, and the red light LR emitted from the light source units 111, 112, and 113 while rotating about the first rotational axis C1.

The blue light LB is incident on the first position P11 of the first transmissive optical part 13. The green light LG is incident on a second position P12 different from the first position P11 of the first transmissive optical part 13. The red light LR is incident on a third position P13 different from the first position P11 and the second position P12 of the first transmissive optical part 13. That is, the blue light LB, the green light LG, and the red light LR are incident on respective positions different from each other in the first transmissive optical part 13. In particular in the case of the present embodiment, since the first light source unit 111, the second light source unit 112, and the third light source unit 113 are in a positional relationship of rotating by 90 degrees around the intersection between the optical axes AX1, AX2, and AX3, the blue light LB, the green light LG, and the red light LR are incident on the respective first side surfaces 13c different from each other of the first transmissive optical part 13.

The behavior of each of the colored light LB, LG, and LR when transmitted through the first transmissive optical part 13 is the same as the behavior illustrated in FIGS. 4A to 4F, and therefore the description thereof will be omitted.

In the case of the present embodiment, the green light LG is linearly elongated in the Y-axis direction perpendicular to the Z-axis direction in which the green light LG is displaced. Therefore, the two-dimensional illumination target region on an illumination target surface (the light modulation device 130) is scanned with the green light LG. Although the blue light LB and the red light LR are different in emission direction from the green light LG, the blue light LB and the red light LR are reflected by the respective optical parts 16a, 16b described later, and then the two-dimensional illumination target region of the illumination target surface (the light modulation device 130) is scanned with the blue light LB and the red light LR similarly to the case of the green light LG. As described above, the first transmissive optical part 13, when rotated around the first rotational axis C1, scans the two-dimensional illumination target region in the light modulation device 130 as the illumination target surface with the blue light LB, the green light LG, and the red light LR in the Z-axis direction perpendicular to the Y-axis direction.

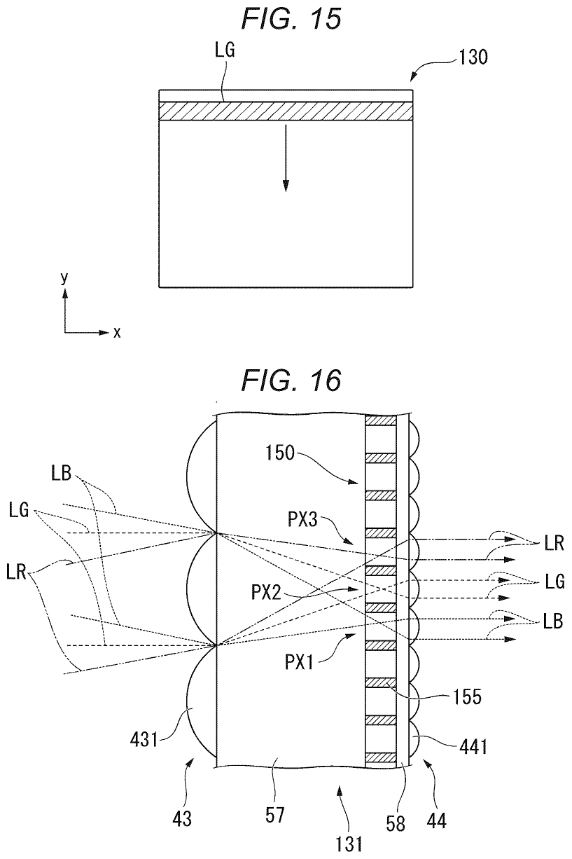

FIG. 15 is a diagram showing a state of scanning light on the light modulation device 130.

In the case of the present embodiment, as shown in FIG. 13, for example, the green light LG in a strip shape is moved in scanning in a single direction along the up-down direction y on the light modulation device 130.

Therefore, the coordinates px, dx(t) in the left-right direction x are in a constantly coinciding state in Formula (5) described above for defining the timing of the light control of the light control target pixel. Therefore, in the case of the present embodiment, in Formula (5), the term px-dx(t) is constantly 0. Note that the blue light LB and the red light LR are moved in scanning in a single direction along the up-down direction y on the light modulation device 130 in a similar manner.

Accordingly, in the case of the present embodiment, it is sufficient for the control device CONT to perform the light control of the light control target pixel at the timing which satisfies Formula (6) described below.

$$\sqrt{{( {p}_{y} - {d}_{y} ( t ) )}^{2}} ≦ r \qquad ( 6 )$$

That is, in the case of the present embodiment, since it is sufficient for the control device CONT to consider only the coordinates in the up-down direction y in which the colored light LB, LG, and LR moves in scanning, the processing of the light control becomes easy compared to when considering the coordinates in two directions, namely, the left-right direction x and the up-down direction Y.

The first optical part 16a is disposed on the light path of the blue light LB emitted from the first light source unit 111 between the first light source unit 111 and the first transmissive optical part 13. The first optical part 16a is formed of a dichroic mirror that reflects the red light and transmits the blue light. Therefore, the first optical part 16a reflects the red light LR emitted from the first transmissive optical part 13 and transmits the blue light LB emitted from the first light source unit 111. An angle between the first optical part 16a and the Z axis is referred to as an inclination angle θ11 of the first optical part 16a. The inclination angle θ11 of the first optical part 16a is larger than 45 degrees.

The second optical part 16b is disposed on the light path of the red light LR emitted from the third light source unit 113 between the third light source unit 113 and the first transmissive optical part 13. The second optical part 16b is formed of a dichroic mirror that reflects the blue light and transmits the red light. Therefore, the second optical part 16b reflects the blue light LB emitted from the first transmissive optical part 13 and transmits the red light LR emitted from the third light source unit 113. An angle between the second optical part 16b and the Z axis is referred to as an inclination angle θ12 of the second optical part 16b. The inclination angle θ12 of the second optical part 16b is larger than 45 degrees.

Since the inclination angle θ12 of the second optical part 16b is set to be greater than 45 degrees, the blue light LB reflected by the second optical part 16b travels obliquely with respect to and toward the optical axis AX2. Similarly, since the inclination angle θ11 of the first optical part 16a is set to be greater than 45 degrees, the red light LR reflected by the first optical part 16a travels obliquely with respect to and toward the optical axis AX2.

Thus, the blue light LB reflected by the second optical part 16b, the green light LG output from the first transmissive optical part 13, and the red light LR reflected by the first optical part 16a enter a first microlens array 43 in the anterior stage of a light modulation part 131 from respective directions different from each other as described later, and overlap each other on the first microlens array 43. In the case of the present embodiment, the incidence angle of the green light LG incident on the first microlens array 43 is 0 degree. In other words, the green light LG is incident on the first microlens array 43 at right angle.

The light modulation device 130 of the present embodiment includes the light modulation part 131 and an exit-side polarization plate 132.

FIG. 16 is a cross-sectional view illustrating a configuration of an essential part of the light modulation device 130 in the present embodiment. In FIG. 16, a cross-sectional configuration of the light modulation part 131 is illustrated, and illustration of the exit-side polarization plate 132 is omitted.

As shown in FIG. 16, a liquid crystal panel that constitutes the light modulation part 131 has an image forming region 150 in which a plurality of blue sub-pixels PX1, a plurality of green sub-pixels PX2, and a plurality of red sub-pixels PX3 are periodically arranged in a matrix. The blue sub-pixels PX1 modulate the blue light LB. The green sub-pixels PX2 modulate the green light LG. The red sub-pixels PX3 modulate the red light LR. One pixel, which is a minimum unit of an image, is formed of one blue sub-pixel PX1, one green sub-pixel PX2, and one red sub-pixel PX3. A light blocking film 155 referred to as a black matrix is disposed between two sub-pixels adjacent to each other.

The first microlens array 43 is disposed at the light incident side of the first substrate 57 constituting the light modulation part 131. The first microlens array 43 has a configuration in which a plurality of first microlenses 431 is arranged in a matrix. The first microlens array 43 collects the blue light LB, the green light LG, and the red light LR, and guides the light to the sub-pixels PX1, PX2, and PX3 of the light modulation part 131. Each of the first microlenses 431 is formed of a lenticular lens, and is disposed across one pixel, that is, three sub-pixels PX1, PX2, and PX3 corresponding to the different colors and arranged in one direction. As each of the first microlenses 431, the lenticular lens is cited in the present embodiment, but this is not a limitation, and it is possible to adopt a microlens array in which rectangular lenses are arranged in a laid brick form, a microlens array in which lenses are arranged in correspondence with sub-pixels in a delta arrangement, or a microlens array having a honeycomb structure.

As described above, the blue light LB, the green light LG, and the red light LR are incident on each of the first microlenses 431 at respective angles of incidence different from each other, and therefore travel in respective directions different from each other, and are then collected. Accordingly, the blue light LB is incident on the blue sub-pixel PX1, the green light LG is incident on the green sub-pixel PX2, and the red light LR is incident on the red sub-pixel PX3. That is, the first microlens array 43 causes the blue light LB emitted from the second optical part to be incident on the blue sub-pixels PX1, causes the green light LG emitted from the first transmissive optical part to be incident on the green sub-pixels PX2, and causes the red light LR emitted from the first optical part to be incident on the red sub-pixels PX3.

The second microlens array 44 is disposed at the light exit side of a second substrate 58 constituting the light modulation part 131. The second microlens array 44 has a configuration in which a plurality of second microlenses 441 are arranged in a matrix. The second microlens array 44 collimates each of the three types of colored light emitted from the liquid crystal panel. The second microlens 441 is provided to each of the sub-pixels. Note that the example in which each colored light is collimated after being emitted from the liquid crystal panel is cited in the present embodiment, but instead of this configuration, the second microlens array 44 may be disposed at the light incidence side of the liquid crystal panel, and each colored light may be collimated before entering the liquid crystal panel.

The exit-side polarization plate 22 is disposed on the optical axis AX2 between the light modulation part 131 and the projection optical device 23. The exit-side polarization plate 22 transmits the linearly polarized light, which is emitted from the light modulation part 131 and is polarized in a specific direction, toward the projection optical device 23.

According to the projector 202 of the present embodiment, the control device CONT adjusts the outputs of the light source units 111, 112, and 113 based on the image information to perform the light control of the colored light LB, LG, and LR for illuminating the illumination target region (the light control target pixel of the light modulation part 131), and therefore, it is possible to obtain substantially the same advantages as in the first embodiment such as an advantage that the light use efficiency of the light source device 110 is improved to realize the low power consumption.

Further, in the projector 202 according to the present embodiment, the three types of colored light LB, LG, and LR can be spatially separated and the three types of colored light LB, LG, and LR can be made incident on the sub-pixels PX1, PX2, and PX3 corresponding thereto by the arrangement of the light source units 111, 112, and 113, the first transmissive optical part 13, and the optical parts 16a, 16b and the function of the first microlens array 43 provided to the light modulation device 130. Thus, it is possible to realize the projector 202 capable of displaying a color image without using a color filter in the light modulation part 131 of the light modulation device 130. Furthermore, since the illumination target region of the light modulation device 130 can two-dimensionally be illuminated by scanning the illumination target region in the Z-axis direction with the colored light LB, LG, and LR having the long axis in the Y-axis direction, just one transmissive optical part is sufficient, and simplification of the apparatus configuration and a reduction in size can be achieved.

Note that the technical scope of the present disclosure is not limited to the embodiments described above, and a variety of changes can be made without departing from the scope of the present disclosure.

For example, in the first embodiment, there is cited, as an example, when the illumination light WL obtained by combining the colored light LB, LG, and LR travels through the first transmissive optical part 13 and the second transmissive optical part 14, and is then color-separated, and then the respective light modulation parts 30B, 30G, and 30R are scanned with the colored light thus color-separated, but the present disclosure is not limited to this example. For example, the present disclosure may be applied to a configuration in which the colored light LB, LG, and LR travels through the first transmissive optical part 13 and the second transmissive optical part 14, respectively, and then the light modulation parts 30B, 30G, and 30R are scanned with the colored light, respectively.

In the second embodiment, there is cited, as an example, when the colored light LB, LG, and LR is incident on one transmissive optical part from respective directions different from each other, and the colored light LB, LG, and LR is made incident on one liquid crystal panel from the three directions, respectively, but the present disclosure is not limited to this example. For example, the present disclosure may be applied to a configuration in which three transmissive optical parts corresponding to the colored light beam LB, LG, and LR having a strip shape, and three light modulation parts corresponding to the three transmissive optical parts are provided, and the light modulation parts are scanned with the colored light LB, LG, and LR emitted from the transmissive optical parts, respectively.

In addition, the specific description of the shapes, the numbers, the arrangements, the materials, and the like of the respective component parts of the light source device and the projector are not limited to those in the above described embodiments, but changes can be made as appropriate. Further, in the above described embodiments, the example in which the light source device according to the present disclosure is provided in the projector using the liquid crystal panels is shown, however, the application is not limited to that. The light source device according to the present disclosure may be applied to a projector using digital micromirror devices as the light modulation devices.

The present disclosure will be summarized below as additional remarks.

### Additional Remark 1

A projector including
a light source unit configured to emit light,
a first transmissive optical part including a first plane of incidence on which the light emitted from the light source unit is incident, and a first exit surface configured to emit the light incident from the first plane of incidence,
a first rotating part configured to rotate the first transmissive optical part,
a light modulation device configured to modulate, based on image information, the light emitted from the first transmissive optical part to generate image light, and
a control device configured to control an output of the light source unit, in which
the light modulation device includes an image forming region containing a plurality of pixels,
the first transmissive optical part is a light transmissive member having the first plane of incidence and the first exit surface parallel to each other, and rotates around a first rotational axis extending along a second direction crossing a first direction which is an incident direction of the light with respect to the first transmissive optical part to thereby scan the image forming region of the light modulation device with the light emitted from the light source unit,
the control device performs light control of adjusting light intensity of the light to be incident on a light control target pixel by
selecting the light control target pixel from among the plurality of pixels based on the image information,
decreasing the output of the light source unit when a luminance value corresponding to the light control target pixel in the image light is smaller than a light control reference value, and
increasing the output of the light source unit when the luminance value is larger than the light control reference value at a timing which satisfies the following conditional expression when defining a position coordinate of the light control target pixel in the image forming region as (px, py), a radius in a scanning direction of the light on the image forming region as r, and a position coordinate of the light on the image forming region at a time t as (dx(t), dy(t)).

$$\sqrt{{\{ {p}_{x} - {d}_{x} ( t ) \}}^{2} + {\{ {p}_{y} - {d}_{y} ( t ) \}}^{2}} ≦ r$$

According to the projector of this configuration, since the control device performs the light control of the light emitted from the light source unit toward the light control target pixel based on the image information, it is possible to reduce the light intensity blocked by the light modulation device. Accordingly, the light use efficiency of the light emitted from the light source unit can be improved.

According to this configuration, it is possible to achieve the reduction in power consumption, and to realize a projector excellent in display quality.

### Additional Remark 2

The projector described in Additional Remark 1, in which,
when setting a plurality of light control target pixels from among the plurality of pixels, the control device performs the light control in accordance with a passing order in which the light with which the image forming region is scanned passes through the plurality of light control target pixels.

According to this configuration, the light control can be performed at an appropriate timing when the light passes through each light control target pixel.

### Additional Remark 3

The projector described in Additional Remark 1 or 2, in which the image information includes a plurality of image frames, and the control device performs the light control in accordance with a timing at which each of the plurality of image frames is input to the light modulation device.

According to this configuration, the light control can be performed on each of the plurality of image frames constituting the image information.

### Additional Remark 4

The projector described in any one of Additional Remarks 1 to 3, in which
the first transmissive optical part includes a first surface and a second surface crossing the first rotational axis, and 2×m (m: a natural number no smaller than 2) first side surfaces in contact with the first surface and the second surface, and
the first plane of incidence and the first exit surface are two first side surfaces parallel to each other out of the 2×m first side surfaces.

According to this configuration, since there is no light incident on the first side surfaces that are not parallel to each other, the stray light rarely occurs in the first transmissive optical part, it is possible to increase the light use efficiency.

### Additional Remark 5

The projector described in Additional Remark 4, in which the first transmissive optical part has a square cross-sectional shape along a plane perpendicular to the first rotational axis, and a refractive index of the first transmissive optical part is no lower than 1.63.

According to this configuration, the determination coefficient of the graph representing the relationship between the rotation angle and the displacement amount of the first transmissive optical part becomes no smaller than 0.995. Accordingly, the uniformity of the illuminance distribution of the light in the illumination target region can be improved by increasing the linearity of the graph.

### Additional Remark 6

The projector described in Additional Remark 4, in which the first transmissive optical part has a regular hexagonal cross-sectional shape along a plane perpendicular to the first rotational axis, and a refractive index of the first transmissive optical part is no lower than 1.14.

According to this configuration, the determination coefficient of the graph representing the relationship between the rotation angle and the displacement amount of the first transmissive optical part becomes no smaller than 0.995. Accordingly, the uniformity of the illuminance distribution of the light in the illumination target region can be improved by increasing the linearity of the graph while suppressing the refractive index of the first transmissive optical part to a low level.

### Additional Remark 7

The projector described in Additional Remark 4, in which the first transmissive optical part has a regular polygonal cross-sectional shape along a plane perpendicular to the first rotational axis, the regular polygonal shape being no smaller in a number of sides than an octagonal shape.

According to this configuration, even when the refractive index of the first transmissive optical part is set within an ordinary range of 1 to 2.73, the linearity of the graph can sufficiently be increased. Accordingly, since the restriction of the refractive index in the first transmissive optical part is reduced, the room for choice of the materials available as the first transmissive optical part is widened, and the optical design of the first transmissive optical part is facilitated.

### Additional Remark 8

The projector described in any one of Additional Remarks 1 to 7, in which the light source unit includes a light emitting part including a laser diode configured to emit a laser beam.

According to this configuration, since the light emitted from the light source unit is a linearly polarized laser beam, when using the liquid crystal panel, for example, as the light modulation device, the incident side polarization plate can be omitted.

### Additional Remark 9

The projector described in any one of Additional Remarks 1 to 8, in which the control device further controls drive of the first rotating part and the light modulation device.

According to this configuration, since the control device collectively controls the light control of the light source unit, the drive control of the first rotating part, and the drive control of the light modulation device, it becomes possible to perform simple and accurate control.

### Additional Remark 10

The projector described in any one of Additional Remarks 1 to 9, in which
the control device includes an image processing unit configured to perform predetermined image processing on the image information, and
the control device calculates a light intensity of the light incident on the light control target pixel based on the image information after the image processing is performed on the image information by the image processing unit.

According to this configuration, the control device performs the light control of the light with which the image forming region is scanned based on, for example, the image information compatible with the display mode, and therefore, it is possible to display the high-quality image more suitable for the display mode.

### Additional Remark 11

The projector described in any one of Additional Remarks 1 to 10, further comprising
a second transmissive optical part having a second plane of incidence on which the light is incident and a second exit surface configured to emit the light incident from the second plane of incidence, and
a second rotating part configured to rotate the second transmissive optical part, in which
the second transmissive optical part is a light transmissive member in which the second plane of incidence and the second exit surface are parallel to each other, and rotates around a second rotational axis extending along a third direction crossing each of the first direction and the second direction, and
the second rotating part rotates the second transmissive optical part around the second rotational axis to thereby two-dimensionally scan the image forming region of the light modulation device with the light.

According to this configuration, it is possible to easily realize a configuration in which the entire image forming region is illuminated by two-dimensionally scanning the image forming region with the light using the first transmissive optical part and the second transmissive optical part.

### Additional Remark 12

The projector described in Additional Remark 11, in which
the second transmissive optical part includes a third surface and a fourth surface crossing the second rotational axis, and 2×n (n: a natural number no smaller than 2) second side surfaces in contact with the third surface and the fourth surface, and
the second plane of incidence and the second exit surface are two second side surfaces parallel to each other out of the 2×n second side surfaces.

According to this configuration, since there is no light incident on the second side surfaces that are not parallel to each other, the stray light rarely occurs in the second transmissive optical part, it is possible to increase the light use efficiency.

### Additional Remark 13

The projector described in any one of Additional Remarks 1 to 11, in which
the light source unit includes
a first light source unit configured to emit first light in a first wavelength band,
a second light source unit configured to emit second light in a second wavelength band different from the first wavelength band, and
a third light source unit configured to emit third light in a third wavelength band different from the first wavelength band and the second wavelength band,
the light modulation device includes
a first light modulation part configured to modulate the first light emitted from the first transmissive optical part based on first image information to generate first image light,
a second light modulation part configured to modulate the second light emitted from the first transmissive optical part based on second image information to generate second image light, and
a third light modulation part configured to modulate the third light emitted from the first transmissive optical part based on third image information to generate third image light, and
the control device controls an output of the first light source unit to adjust a light intensity of the first light incident on the light control target pixel of the first light modulation part based on the first image information, controls an output of the second light source unit to adjust a light intensity of the second light incident on the light control target pixel of the second light modulation part based on the second image information, and controls an output of the third light source unit to adjust a light intensity of the third light incident on the light control target pixel of the third light modulation part based on the third image information.

According to this configuration, since the light emitted from each of the first, second, and third light source units toward the control target pixels of the first, second, and third light modulation parts is subjected to the light control, the amount of the light blocked by each light modulation part can be suppressed. This can improve the light use efficiency of the light emitted from the first, second, and third light source units.

Therefore, it is possible to achieve the reduction in power consumption, and to realize a 3-panel projector excellent in display quality.

What is claimed is:

1. A projector comprising:
a light source unit configured to emit light;
a first transmissive optical part including a first plane of incidence on which the light emitted from the light source unit is incident, and a first exit surface configured to emit the light incident from the first plane of incidence;
a first rotating part configured to rotate the first transmissive optical part;
a light modulation device configured to modulate, based on image information, the light emitted from the first transmissive optical part to generate image light; and
a control device configured to control an output of the light source unit, wherein
the light modulation device includes an image forming region containing a plurality of pixels,
the first plane of incidence and the first exit surface of the first transmissive optical part are parallel to each other, and the first transmissive optical part rotates around a first rotational axis extending along a second direction crossing a first direction which is an incident direction of the light with respect to the first transmissive optical part to thereby scan the image forming region of the light modulation device with the light emitted from the light source unit,
the control device performs light control of adjusting light intensity of the light to be incident on a light control target pixel by
selecting the light control target pixel from among the plurality of pixels based on the image information,
decreasing the output of the light source unit when a luminance value corresponding to the light control target pixel in the image light is smaller than a light control reference value, and
increasing the output of the light source unit when the luminance value is larger than the light control reference value at a timing which satisfies the following conditional expression when defining a position coordinate of the light control target pixel in the image forming region as (px, py), a radius in a scanning direction of the light on the image forming region as r, and a position coordinate of the light on the image forming region at a time t as (dx(t), dy(t)).
$$\sqrt{{\{ {p}_{x} - {d}_{x} ( t ) \}}^{2} + {\{ {p}_{y} - {d}_{y} ( t ) \}}^{2}} ≦ r$$

2. The projector according to claim 1, wherein,
when setting a plurality of light control target pixels from among the plurality of pixels, the control device performs the light control in accordance with a passing order in which the light with which the image forming region is scanned passes through the plurality of light control target pixels.

3. The projector according to claim 1, wherein
the image information includes a plurality of image frames, and
the control device performs the light control in accordance with a timing at which each of the plurality of image frames is input to the light modulation device.

4. The projector according to claim 1, wherein
the first transmissive optical part includes a first surface and a second surface crossing the first rotational axis, and 2×m (m: a natural number no smaller than 2) first side surfaces in contact with the first surface and the second surface, and
the first plane of incidence and the first exit surface are two first side surfaces parallel to each other out of the 2×m first side surfaces.

5. The projector according to claim 4, wherein
the first transmissive optical part has a square cross-sectional shape along a plane perpendicular to the first rotational axis, and
a refractive index of the first transmissive optical part is no lower than 1.63.

6. The projector according to claim 4, wherein
the first transmissive optical part has a regular hexagonal cross-sectional shape along a plane perpendicular to the first rotational axis, and
a refractive index of the first transmissive optical part is no lower than 1.14.

7. The projector according to claim 4, wherein
the first transmissive optical part has a regular polygonal cross-sectional shape along a plane perpendicular to the first rotational axis, the regular polygonal shape being no smaller in a number of sides than an octagonal shape.

8. The projector according to claim 1, wherein
the light source unit includes a light emitting part including a laser diode configured to emit a laser beam.

9. The projector according to claim 1, wherein
the control device further controls drive of the first rotating part and the light modulation device.

10. The projector according to claim 1, wherein
the control device includes an image processing unit configured to perform predetermined image processing on the image information, and
the control device calculates a light intensity of the light incident on the light control target pixel based on the image information after the image processing is performed on the image information by the image processing unit.

11. The projector according to claim 1, further comprising:
a second transmissive optical part having a second plane of incidence on which the light is incident and a second exit surface configured to emit the light incident from the second plane of incidence; and
a second rotating part configured to rotate the second transmissive optical part, wherein
the second transmissive optical part is a light transmissive member in which the second plane of incidence and the second exit surface are parallel to each other, and rotates around a second rotational axis extending along a third direction crossing each of the first direction and the second direction, and
the second rotating part rotates the second transmissive optical part around the second rotational axis to thereby two-dimensionally scan the image forming region of the light modulation device with the light.

12. The projector according to claim 11, wherein
the second transmissive optical part includes a third surface and a fourth surface crossing the second rotational axis, and 2×n (n: a natural number no smaller than 2) second side surfaces in contact with the third surface and the fourth surface, and
the second plane of incidence and the second exit surface are two second side surfaces parallel to each other out of the 2×n second side surfaces.

13. The projector according to claim 1, wherein
the light source unit includes
a first light source unit configured to emit first light in a first wavelength band,
a second light source unit configured to emit second light in a second wavelength band different from the first wavelength band, and
a third light source unit configured to emit third light in a third wavelength band different from the first wavelength band and the second wavelength band,
the light modulation device includes
a first light modulation part configured to modulate the first light emitted from the first transmissive optical part based on first image information to generate first image light,
a second light modulation part configured to modulate the second light emitted from the first transmissive optical part based on second image information to generate second image light, and
a third light modulation part configured to modulate the third light emitted from the first transmissive optical part based on third image information to generate third image light, and
the control device controls an output of the first light source unit to adjust a light intensity of the first light incident on the light control target pixel of the first light modulation part based on the first image information, controls an output of the second light source unit to adjust a light intensity of the second light incident on the light control target pixel of the second light modulation part based on the second image information, and controls an output of the third light source unit to adjust a light intensity of the third light incident on the light control target pixel of the third light modulation part based on the third image information.
